(19) United States
(12) Patent Application Publication
(10) Pub. No.: US 2015/0332413 A1
(43) Pub. Date: Nov. 19, 2015

(54) System and Method for Electronically Creating, Filing and Approving Applications For Insurance Coverage

(71) Applicant: Data Control Organization, Granite Bay, CA (US)

(72) Inventor: J Dale Debber, Granite Bay, CA (US)

(21) Appl. No.: 14/810,358

(22) Filed: Jul. 27, 2015

Related U.S. Application Data
(63) Continuation of application No. 11/055,588, filed on Feb. 9, 2005.
Application No. 11/055,588 is a continuation of application No. 10/290,974, filed on Nov. 7, 2002, now abandoned.
(60) Provisional application No. 60/336,887, filed on Nov. 7, 2001.

(51) Int. Cl. G06Q 40/08

(52) U.S. Cl. CPC G06Q 40/08

(57) ABSTRACT

A system for electronically creating, filing and approving applications for insurance coverage comprises an application processing system, a risk information system, at least one insurer system and a plurality of agent terminals coupled by a network such as the Internet. The application processing system advantageously presents a user interface via an agent terminal to allow a producer to input information. The application processing system creates a completed insurance application from the input information along with additional information gathered form the risk information system. The application processing system generates one or more applications and automatically submits them to respective insurer systems.

### CROSS-REFERENCE TO A RELATED APPLICATION

This application is a continuation of U.S. application Ser. No. 11/055,588, entitled “System and Method for Electronically Creating, Filing and Approving Applications for Insurance Coverage,” filed Feb. 9, 2005, which is a continuation of U.S. application Ser. No. 10/290,974, entitled “System and Method for Electronically Creating, Filing and Approving Applications for Insurance Coverage,” filed Nov. 7, 2002, which claims the benefit under 35 U.S.C. §119(e) of U.S. Provisional Application No. 60/336,887, entitled “System and Method for Electronically Creating, Filing and Approving Applications For Insurance Coverage,” filed on Nov. 7, 2001, the entire contents of each of which are incorporated herein by reference.

### BACKGROUND OF THE INVENTION

1. Field of the Invention

The present invention relates the to the field of automated document processing. More specifically, this invention relates to a system and method for electronically creating, filing and approving applications for insurance coverage.

2. Description of Related Art

The process of getting insurance coverage typically involves a number of parties. First, an insured must meet with a broker or producer to determine the type and scope of insurance coverage that the insured is considering. Second, the producer must interact with an insurer or carrier to write a policy for the insured. This process has historically involved a lot of paper transactions where paper documents are use to provide information between the parties in a transaction. One problem with the existing systems is that while certain processes have been automated, the process end-to-end to secure insurance coverage is very slow since much of the communications and interactions occur with written documents.

Another problem with the existing systems for securing insurance coverage is that there is very little interoperability. For example, many of the large insurance carriers have their own proprietary systems. These systems are typically unable to interact with other systems, and require that any data submitted be in a specific format unique to that carrier. Thus, submission of an application for insurance must be done on a one-by-one basis in the format of each carrier. This forces many producers to generate multiple applications, most often with very much of the same information. Moreover, each carrier may require that various different types of supplemental information accompany the application. Thus, there is a need for a system only requires the data be input once, and provided to multiple carriers.

Yet another problem with existing systems for securing insurance coverage is that the reliability of the input data is suspect. Many producers are not fully diligent about confirming the accuracy of the information provided on an application. Thus, in order to properly underwrite a particular policy, the insurer may require validation as to the accuracy of the data provided in an application for insurance coverage. Thus, there is a need for a system that can automatically verify the risk of insuring a particular individual or company.

Finally, heretofore, there not been a mechanism by which the insurers could enforce territorial or other restrictions between producers. Insurers typically assign producers by area to ensure a consistent level of service, and for other reasons. Historically, a manager (human operator) would have to intervene in the process and make a decision. Thus, there is a need for a system that can automatically handle and enforce territorial restrictions.

What is needed is a method for automatically and electronically creating, filing and approving applications for insurance coverage

### SUMMARY OF THE INVENTION

The present invention overcomes the deficiencies and limitations of the prior art by providing a system and method for electronically creating, filing and approving applications for insurance coverage. The system comprises an application processing system, a risk information system, at least one insurer system and a plurality of agent terminals coupled by a network such as the Internet. The application processing system advantageously presents a user interface via an agent terminal to allow a producer to input information. The application processing system creates a completed insurance application from the input information along with additional information gathered from the risk information system. The application processing system generates one or more applications and automatically submits them to respective insurer systems. The insurer system is coupled for communication with the application processing system to transmit application status, and other information. The present invention also includes a plurality of methods including a method for creating an electronic insurance application and a method for processing the electronic insurance application.

### BRIEF DESCRIPTION OF THE DRAWINGS

The invention is illustrated by way of example and not by way of limitation in the figures of the accompanying drawings in which like reference numerals refer to similar elements.

FIG. 1A illustrates a first embodiment of a system for electronically creating, filing and approving applications for insurance coverage.

FIG. 1B illustrates a second embodiment of the system for electronically creating, filing and approving applications for insurance coverage.

FIG. 2 illustrates a preferred embodiment of a server that may be part of the application processing system, the risk information system, or the insurer's system.

FIG. 3 illustrates a block diagram of an embodiment of a memory of the application processing system.

FIG. 4 illustrates a block diagram of an embodiment of a memory of the risk information system.

FIG. 5 illustrates a block diagram of an embodiment of a memory of the insurer's system.

FIG. 6 is a flowchart of a first embodiment of method for creating, filing and approving applications for insurance coverage.

FIGS. 7A-7C are a flowchart of a second embodiment of method for creating and filing applications for insurance coverage.

FIG. 8 is a flowchart of a method for processing applications for insurance coverage.

FIG. 9 is a graphical representation of a preferred embodiment of the user interface for submitting an electronic application for insurance coverage.

FIG. 10 is a graphical representation of a preferred embodiment of the user interface for selecting destination for the electronic application for insurance coverage, and an interface for collecting supplemental information.

FIG. 11 is a graphical representation of a preferred embodiment of the interface for confirming receipt of an electronic application.

FIG. 12 is a graphical representation of a preferred embodiment of the user interface for reviewing a received electronic application.

FIG. 13 is a graphical representation of a preferred embodiment of the user interface for reviewing the application and providing a list of authorized users.

FIG. 14 is a graphical representation of a preferred embodiment of the user interface for displaying a processing log.

FIG. 15 is a graphical representation of a preferred embodiment of the user interface for showing assigned and unassigned electronic applications.

FIG. 16 is a graphical representation of a preferred embodiment of the user interface for modifying the data in an electronic application.

FIGS. 17A and 17B show an exemplary ACORD worker compensation form with corresponding field numbers.

### DETAILED DESCRIPTION OF THE INVENTION

A method and apparatus electronically creating, filing and approving applications for insurance coverage is described below. In the following description, for purposes of explanation, numerous specific details are set forth in order to provide a thorough understanding of the invention. It will be apparent, however, to one skilled in the art, that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

### 1. System Overview

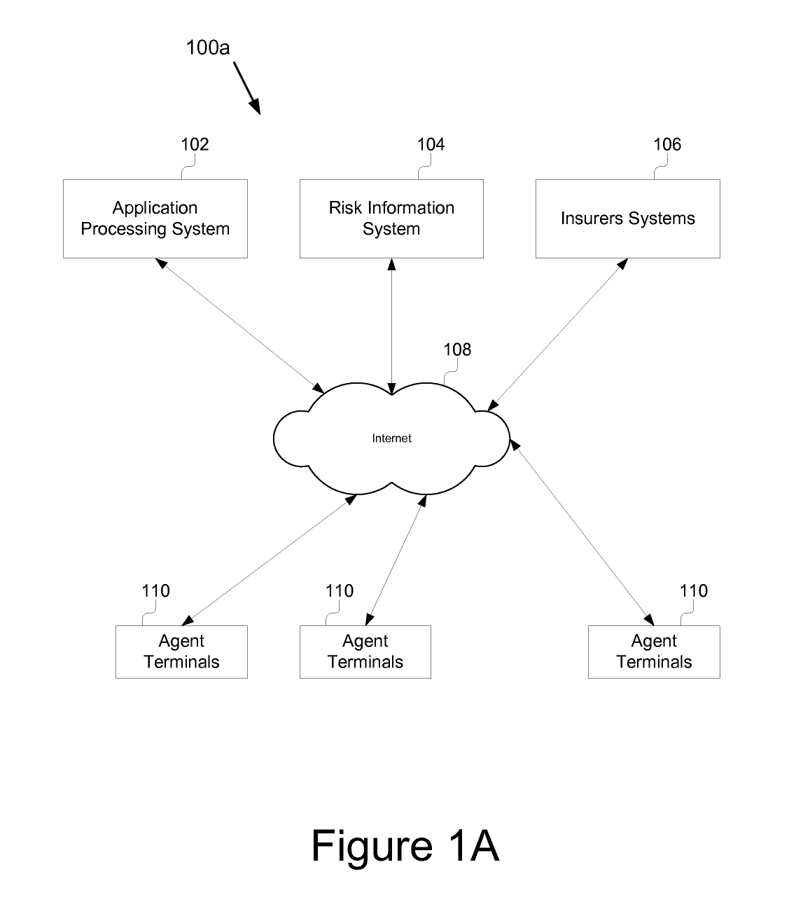

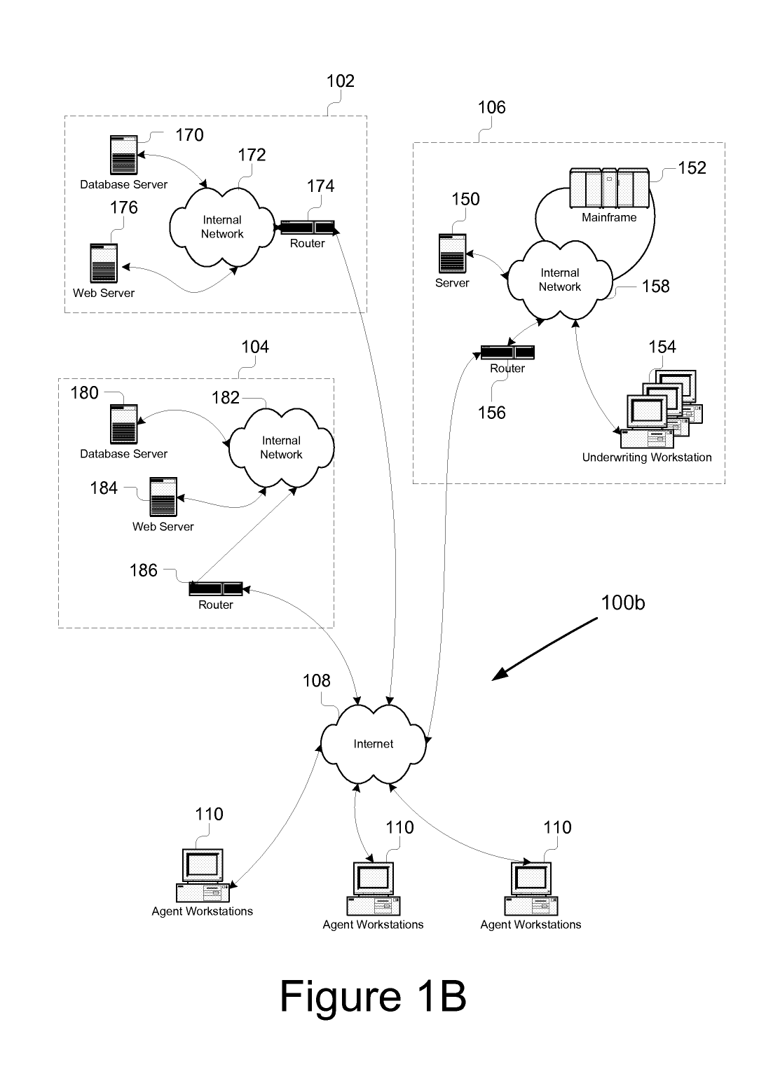

FIG. 1A illustrates a system 100a for electronically creating, filing and approving applications for insurance coverage. The system 100a comprises an application processing system 102, a risk information system 104, at least one insurer system 106 and a plurality of agent terminals 110 coupled together by a network 108 such as the Internet. Although only a single insurer system 106 is shown for convenience and ease of understanding, those skilled in the art will recognize that the Internet 108 can connect any number of insured systems 106 to the system 100a. While the network 108 is referred throughout this application as the Internet, it should be understood that the network 108 could be any or communication medium that is capable of sustaining the traffic and connecting the major components together.

The application processing system 102 works in cooperation with one or more agent terminals 110 to present user interfaces to a person. Using such interfaces, the user inputs data for the electronic application. In addition, the application processing system 102 cooperates and communicates with the risk information system 104 to verify data and retrieve risk information. The application processing system 102 creates a complete application and it supporting forms using the input data and data from the risk information system 104. Then the application processing system 102 transmits the one or more compete applications to designated insurer systems 106 for further processing. The insurer systems 106 are proprietary systems maintained by the insurers.

Referring now to FIG. 1B, a second embodiment for the system 100b is shown. This second embodiment 100b shows an exemplary application processing system 102, risk information system 104, and insurer system 106 in more detail.

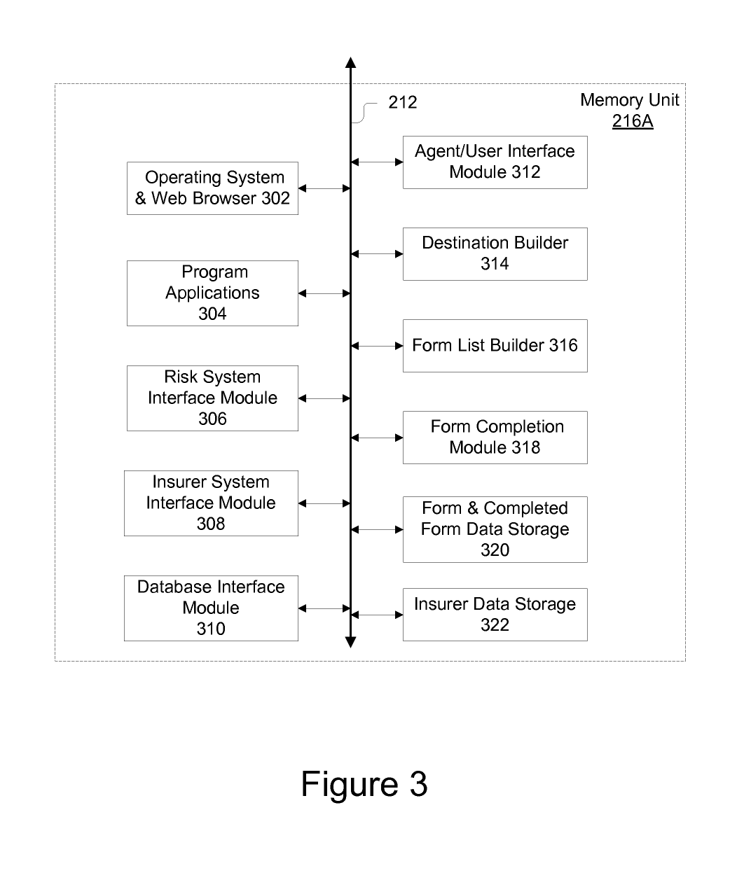

The application processing system 102 includes a database 170 and web server 176. The application processing system 102 has a connection to the Internet 108 via a router, firewall and VPN 174. The connection is similar to that of the insurer system 106. This connection allows a secure connection to be established between the insurer system 106 and the application processing system 102, in particular, its database 170. This arrangement allows the database 170 and the insurer system 106 to be at locations that are not necessarily contiguous. Alternative connection mechanisms are possible whereby the application processing system 102 are local to the insurer system 106. An internal network 172 couples the database 170, the router 174 and web server 176 together. While the database server 170 and web server 176 are shown as single instances of each, it should be understood that there might be a plurality of such database servers 170 and web servers 176. The database server 170 is running the NT version 4 operating system with Microsoft's SQL Server version 7. The web server uses Microsoft Windows NT version 4 operating system with the Internet Information Server installed. The operations and routines of the present invention are shown and described below in FIG. 3 as operating on the web server 176. However, those skilled in the art will recognize that such processing may be divided between the database server 170 and web server 176 or may be an application operating on the database server 170.

The risk information system 104 is a risk information database such as Compline® manufactured and operated by Data Control Corporation of Grass Valley, Calif. The risk information system 104 comprises a database server 180, an internal network 182, a web server 184, and a router 186. The internal network 182 couples the database server 180, the web server 184, and the router 186. The database server 180 is preferably coupled to one or more databases storing information relating to risks. The internal network 182 is connected via a router 186 to the Internet 108 to make the information available via the web server 184 to subscribers using the service.

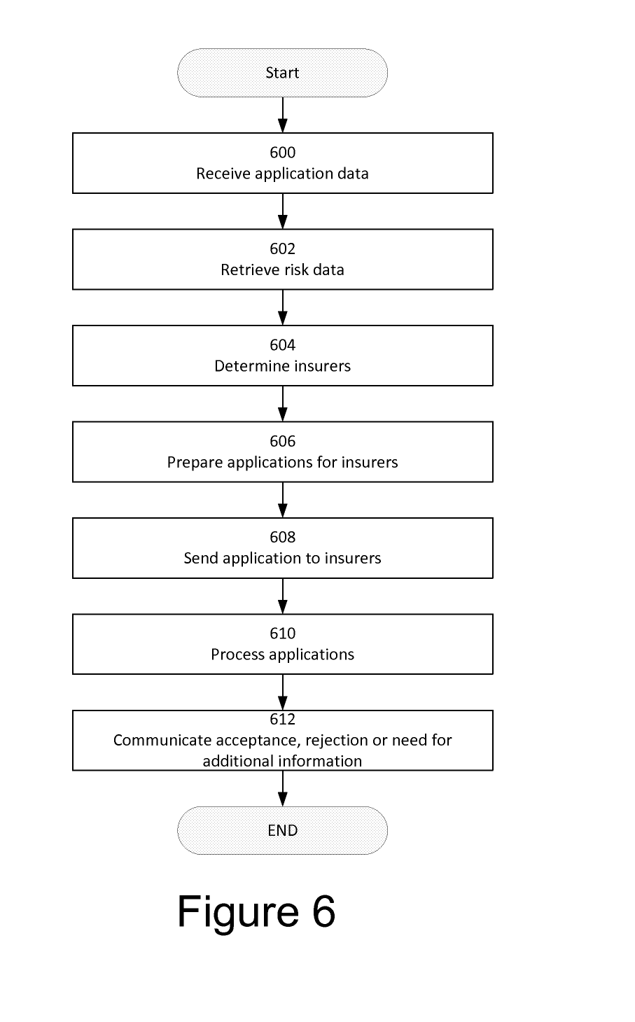

The insurer system 106 is the Insurer's internal computer system that is responsible for accepting applications and maintaining policies after they have been issued. A typical configuration of the insurer system 106 includes a mainframe computer 152 where the records of the insurers policies are maintained. The mainframe 152 is connected to the internal network 158. The internal network 158 may be any one of a variety of local area network running at a variety of speeds and it is connected to the Internet 108 by a connection 156 that consists of a router, a firewall and a Virtual Private Network, (VPN). Also, coupled to the internal network 158 is a server 150. The server 150 is a conventional type as will be described below, except that it include additional software routines (See FIG. 6) for processing electronic applications and communicating with the application processing sever 102. Also connected to the internal network 158 are underwriter's workstations 154 where policies in the process of being issued are reviewed and additional information is entered as necessary.

The agent terminals or workstations 110 are also coupled to the Internet 108 in a conventional manner. The agent workstations 110 are a subsystem of the system 110b, however, they are different because individuals or firms use them to access the risk information system 104 and submit applications on behalf of their clients to the insurer systems 106. The agent workstations 110 are connected for communication with the application processing system 102. The agent workstations 110 in an exemplary embodiment may be a personal computer.

### 2. Basic Server

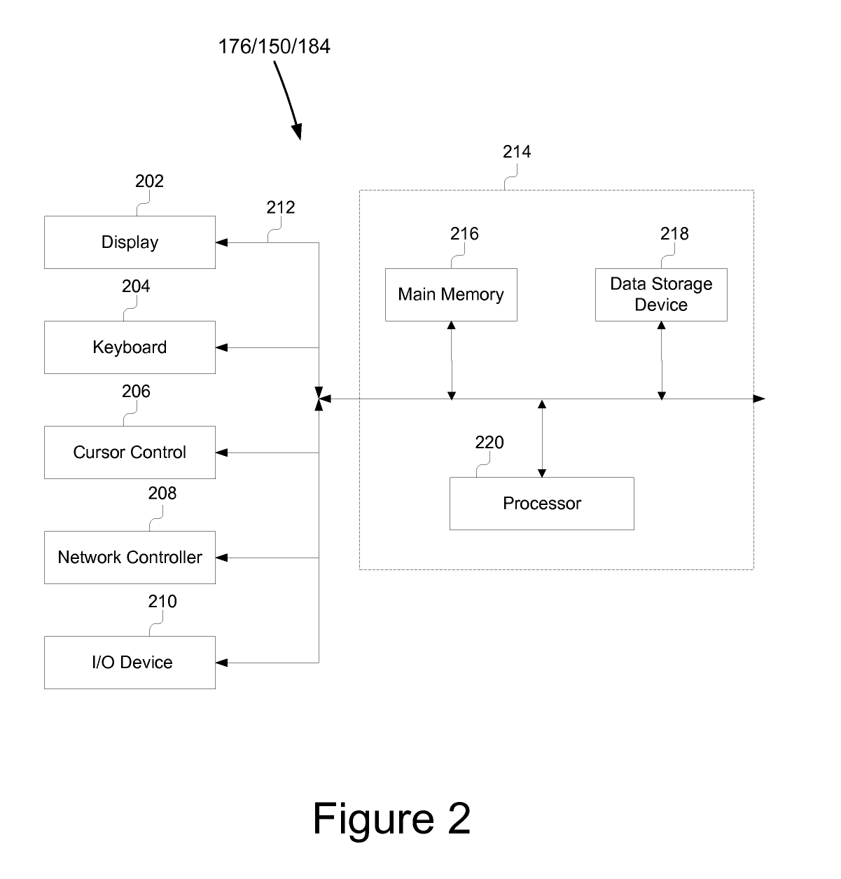

Referring now to FIG. 2, the servers 150, 176, 184 will be described in more detail. The servers 150, 176, 184 have a common hardware architecture that will be described with reference to FIG. 2 for the application-processing server 176, in particular. As shown in FIG. 2, the application-processing server 176 comprises a display device 202, a keyboard 204, a cursor control device 206, a network controller 208, an I/O device 210 and a control unit 214 coupled together by a bus 212.

The display device 202 may comprise any device equipped to display electronic images and data as described herein. Display device 202 may be, for example, a cathode ray tube (CRT), liquid crystal display (LCD), or any other similarly equipped display device, screen, or monitor. In one embodiment, display device 202 is equipped with a touch screen in which a touch-sensitive, transparent panel covers the screen of display device 202.

The keyboard 204 represents an alphanumeric input device coupled to control unit 214 to communicate information and command selections to processor 220.

Cursor control 206 represents a user input device equipped to communicate positional data as well as command selections to processor 220. Cursor control 206 may include a mouse, a trackball, a stylus, a pen, a light pen, cursor direction keys, or other mechanisms to cause movement of a cursor. Furthermore those skilled in the art will recognize that the display device 202 and cursor control 206 may be combined such as in a touch screen.

Network controller 208 links control unit 214 to a network that may include multiple processing systems. The network of processing systems may comprise a local area network (LAN), a wide area network (WAN) (e.g., the Internet), and/or any other interconnected data path across which multiple devices may communicate.

An I/O device 210 is coupled to system bus 212 and is equipped to receive audio input and transmit audio output. Audio input may be received through various devices including a microphone within I/O device 210 and network controller 208. Similarly, audio output may originate from various devices including processor 220 and network controller 208. In one embodiment, I/O device 210 is a general purpose, audio add-in/expansion card designed for use within a general purpose computer system. Optionally, I/O device 210 may contain one or more analog-to-digital or digital-to-analog converters, and/or one or more digital signal processors to facilitate audio processing. While the I/O device 210 has been described in the context of audio, it may also and I/O device for sending and receiving video.

System bus 212 represents a shared bus for communicating information and data throughout control unit 214. System bus 212 may represent one or more buses including an industry standard architecture (ISA) bus, a peripheral component interconnect (PCI) bus, a universal serial bus (USB), or other buses known in the art to provide similar functionality.

Control unit 214 may comprise an arithmetic logic unit, a microprocessor, a general-purpose computer, a personal digital assistant or some other information appliance equipped to provide electronic display signals to display device 202. In one embodiment, control unit 214 comprises a general-purpose computer having a graphical user interface, which may be generated by, for example, WINDOWS®, UNIX® or LINUX® based operating systems. In one embodiment, one or more application programs executed by control unit 214 including, without limitation, word processing applications, electronic mail applications, spreadsheet applications, and web browser applications generate electronic documents. In one embodiment, the operating system and/or one or more application programs executed by control unit 214 provide “drag-and-drop” functionality where each electronic document.

Still referring to FIG. 2, the control unit 214 is shown including a processor 220, main memory 216, and a data storage device 218, all of which are communicatively coupled to system bus 212.

Processor 220 processes data signals and may comprise various computing architectures including a complex instruction set computer (CISC) architecture, a reduced instruction set computer (RISC) architecture, or an architecture implementing a combination of instruction sets. Although only a single processor is shown in FIG. 2, multiple processors may be included.

Main memory 216 may store instructions and/or data that may be executed by processor 220. The instructions and/or data may comprise code for performing any and/or all of the techniques described herein. Main memory 216 may be a dynamic random access memory (DRAM) device, a static random access memory (SRAM) device, or some other memory device known in the art. Main memory 216 will be described in more detail below with reference to FIGS. 3-5 for specific server types including a server 176 in the application processing system 102, a server 184 in the risk information system 104, and a server 150 in the insurer system 106, respectively.

Data storage device 218 stores data and instructions for processor 220 and may comprise one or more devices including a hard disk drive, a floppy disk drive, a CD-ROM device, a DVD-ROM device, a DVD-RAM device, a DVD-RW device, a flash memory device, or some other mass storage device known in the art.

It should be apparent to one skilled in the art that control unit 214 may include more or fewer components than those shown in FIG. 2 without departing from the spirit and scope of the present invention. For example, control unit 214 may include additional memory, such as, for example, a first or second level cache, or one or more application specific integrated circuits (ASICs). Similarly, additional components may be coupled to control unit 214 including, for example, image scanning devices, digital still or video cameras, or other devices that may or may not be equipped to capture and/or download electronic data to control unit 214.

A. Application Processing Server

FIG. 3 illustrates one embodiment of the memory 216A constructed according to the present invention. The memory 216A preferably includes an operating system and web browser 302, program applications 304, a risk system interface module 306, an insurer system interface module 308, a database interface module 310, an agent/user interface module 312, a destination builder 314, a form list builder 316, a form completion module 318, form and completed form storage 320, and insurer data storage 322 communicatively coupled to the bus 212.

The memory 216A preferably includes an operating system and web browser 302. For example, the operating system may be WINDOWS®, UNIX® or LINUX® based operating systems. The web browser may be Microsoft Explorer or Netscape Navigator.

The collection of modules 306, 308, 310, 312, 314, 316, and 318 is coupled to a program application module 304 by the bus 212. The program application module 304 is also coupled to other components of the server 176 by the bus 212. The program application module 304 serves as the central interface between the other elements of the server 176 and the modules 306, 308, 310, 312, 314, 316, and 318. In one embodiment of the invention, the server 176 receives requests to perform an editing function through the keyboard 204, mouse 206, or some other type of input device. Methods of submitting this input are discussed in greater detail below. The program application module 304 interprets the input and activates the appropriate module 306, 308, 310, 312, 314, 316, and 318.

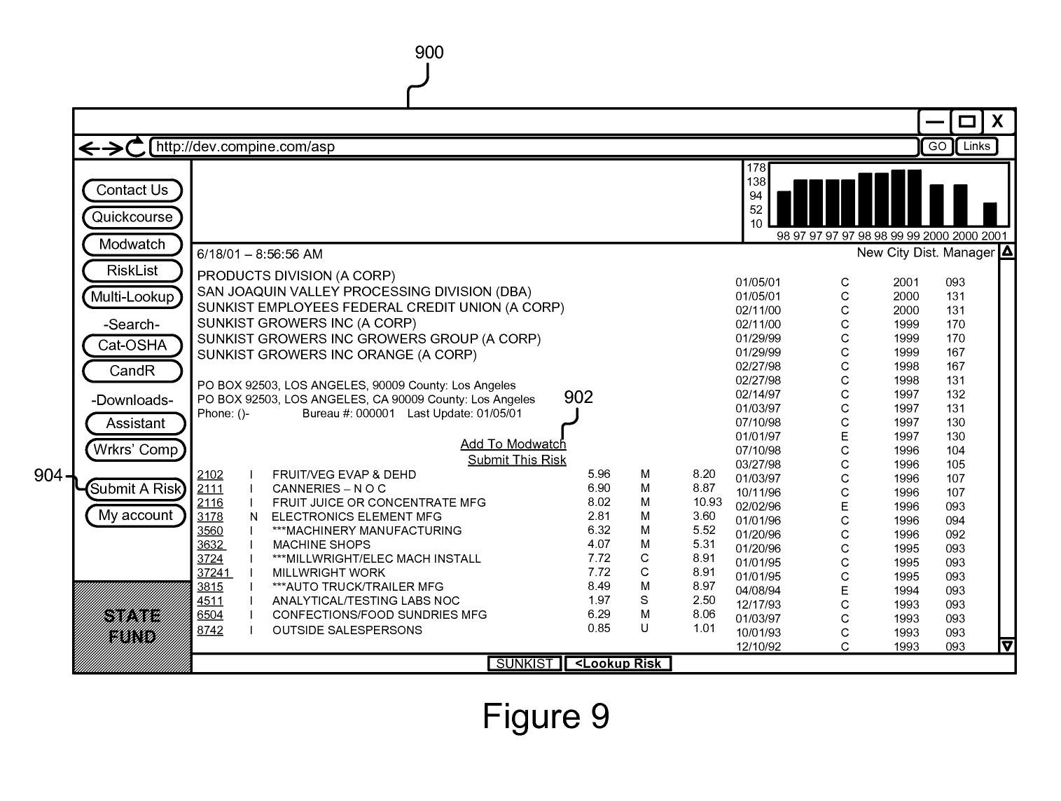

The program application module 304 retrieves the relevant data from insurer data storage 322 and the form and completed form data storage 320 in the main memory 216A and passes it to the appropriate module 306, 308, 310, 312, 314, 316, and 318. The respective module 306, 308, 310, 312, 314, 316, and 318 modifies the data and returns it to the application module 304. The application module 304 sends the updated element information to the memory 216A for storage in the form and completed form data storage 320 or to an output device to update the display 202 to reflect the changes. A primary function of the application module 304 is to generate a user interfaces as will be described in more detail below with reference to FIGS. 9-17.

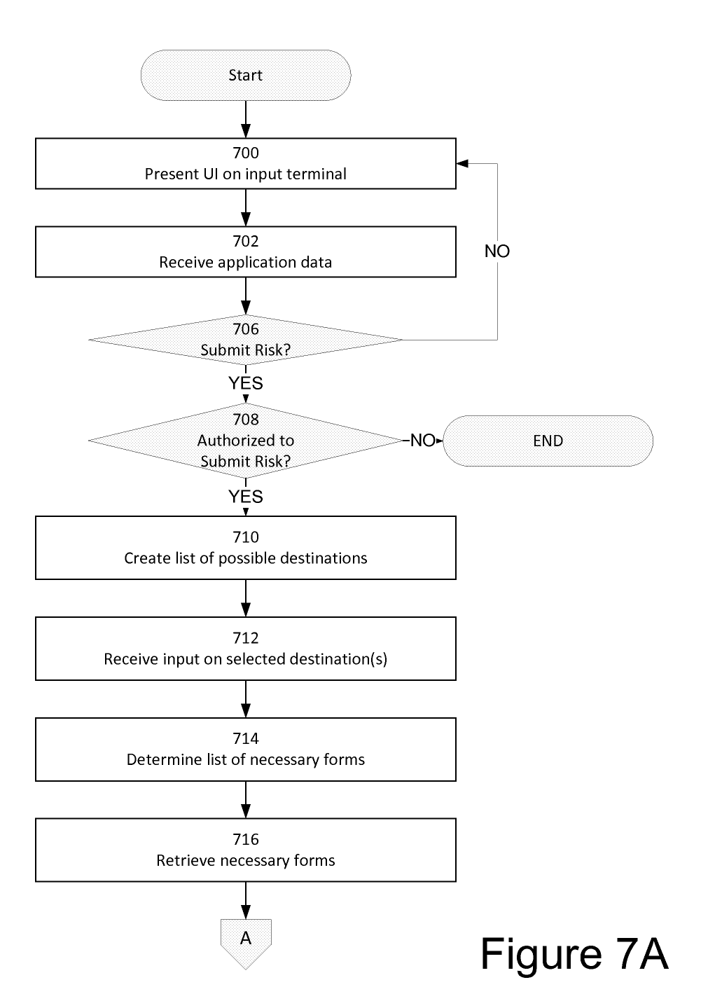

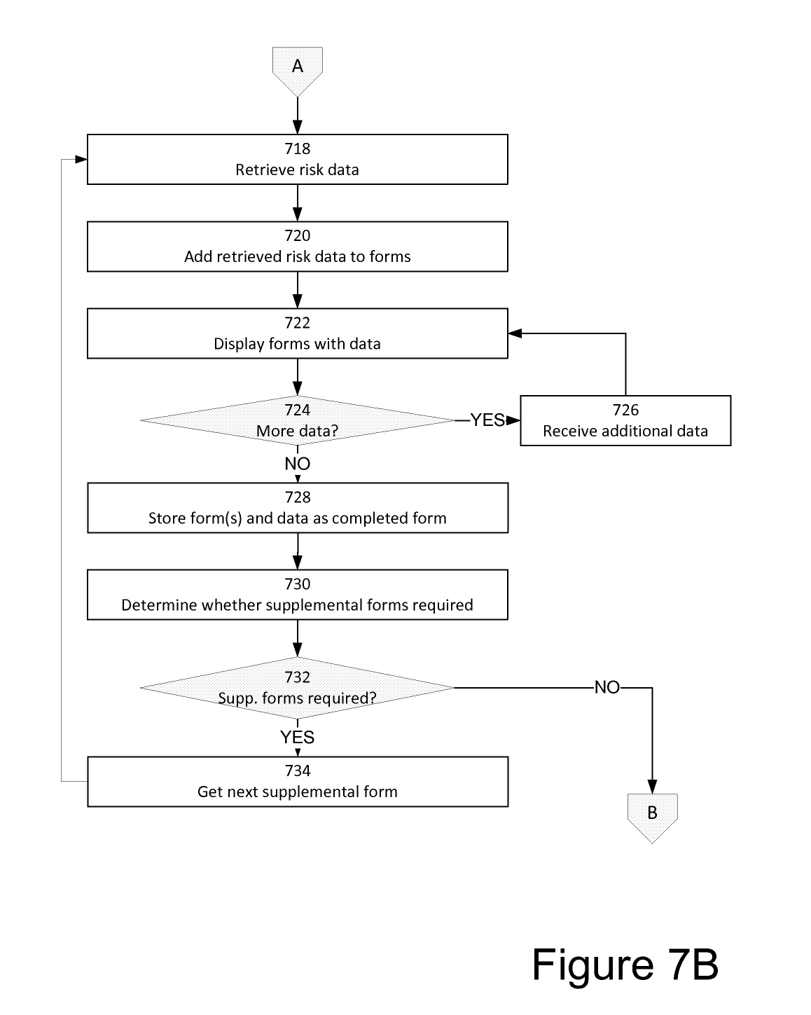

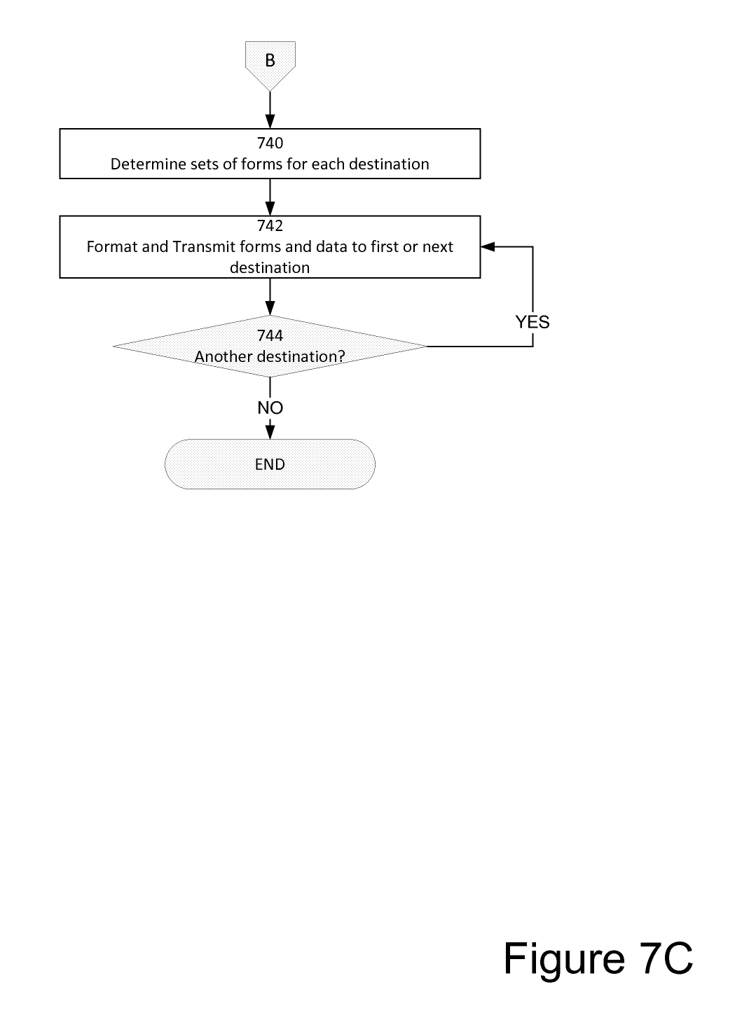

The bus 212 couples the risk system interface module 306 to the program application module 304 and the network controller 208. The risk system interface module 306 is responsive to the program application module 304. The risk system interface module 306 is responsible for communication with risk information system 104. The risk system interface module 306 communicates with the risk information system 104 to extract risk data need to complete the insurance application form. For example, the risk system interface module 306 may be used to populate the basic form as well as supplemental forms required by the insurer with risk data. The risk system interface module 306 may also be used to verify the accuracy of data submitted in the application by comparison to similar data in the risk information system 104. The risk system interface module 306 is responsible for communicating and interacting with the risk information system 104 to provide this information to the program application module 304. This functionality will be described in more detail below with reference to FIGS. 6 and 7A-C.

The insurer system interface module 308 is coupled to the program application module 304 and the network controller 208 by the bus 212. The insurer system interface module 308 is responsive to the program application module 304. The insurer system interface module 308 is responsible for communication with insurer system 106. The insurer system interface module 308 communicates with the insurer system 106 to retrieve the forms and data required by the insurer for various applications. Once received, the insurer system interface module 308 stores this information in the insurer data storage 322. The insurer system interface module 308 also handles other communication with the insurer system 106. For example, the insurer system interface module 308 is responsible for submitting the electronic application to each respective insurer system 106, receiving confirmation, and other communication with respect to the application or its status. Still more particularly, in this embodiment the insurer system interface module 308 interacts with the insurer server 150, or alternatively with the mainframe computer 152. Although only a single insurer system is shown, there may be a plurality of insurer systems that the present invention interacts with. Thus, the insurer system interface module 308 must be able to communication with each different insurer system 106.

The database interface module 310 is coupled to the program application module 304 and the network controller 208 by the bus 212. The database interface module 310 is responsive to the program application module 304. The database interface module 310 is responsible for communication with database 170 that forms the application processing system 102. The database interface module 310 is responsible for storing data to and retrieving data from the database 170. This may include the data such a core forms, supplemental form, completed forms, insurer data, destination data, formatting for insurers or other information used in processing the application. The database interface module 310 is coupled via the network controller 208 to the database 170.

The agent/user interface module 312 handles communication between the agent terminals 110 and the application processing system 120. The agent/user interface module 312 preferably uses HTML or XML and cooperates with the web browser of the agent terminals 110 to present data, and receive input data. As shown below in FIGS. 9-17B, the agent/user interface module 312 presents a variety of screens to allow the user to interact with the system 102.

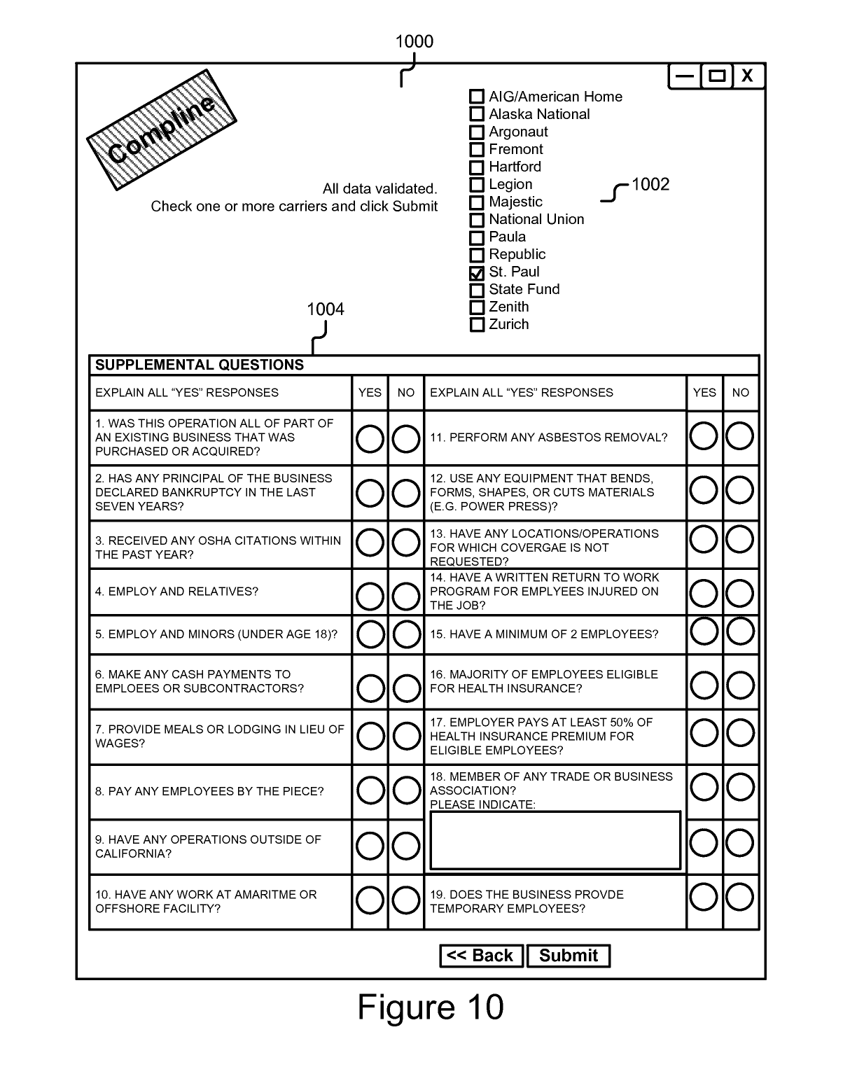

The destination builder 314 is coupled to the program application module 304, the insurer data storage 322 and the database interface module 310 by the bus 212. The destination builder 314 is responsive to the program application module 304. The destination builder 314 is responsible for generating list of possible insurers to which applications may be submitted. The destination builder 314 accesses the insurer data storage 322 to retrieve the data regarding available insurers. The destination builder 314 may also accesses the database 170 via the database interface module 310 if the information is not present in the insurer data storage 322. The destination builder 314 may also store the data in working memory (not shown) for use in later operations by the application program 304. The destination builder 314 also interacts with the agent/user interface module 312 to present available insurer to the user for selection as shown in FIG. 10.

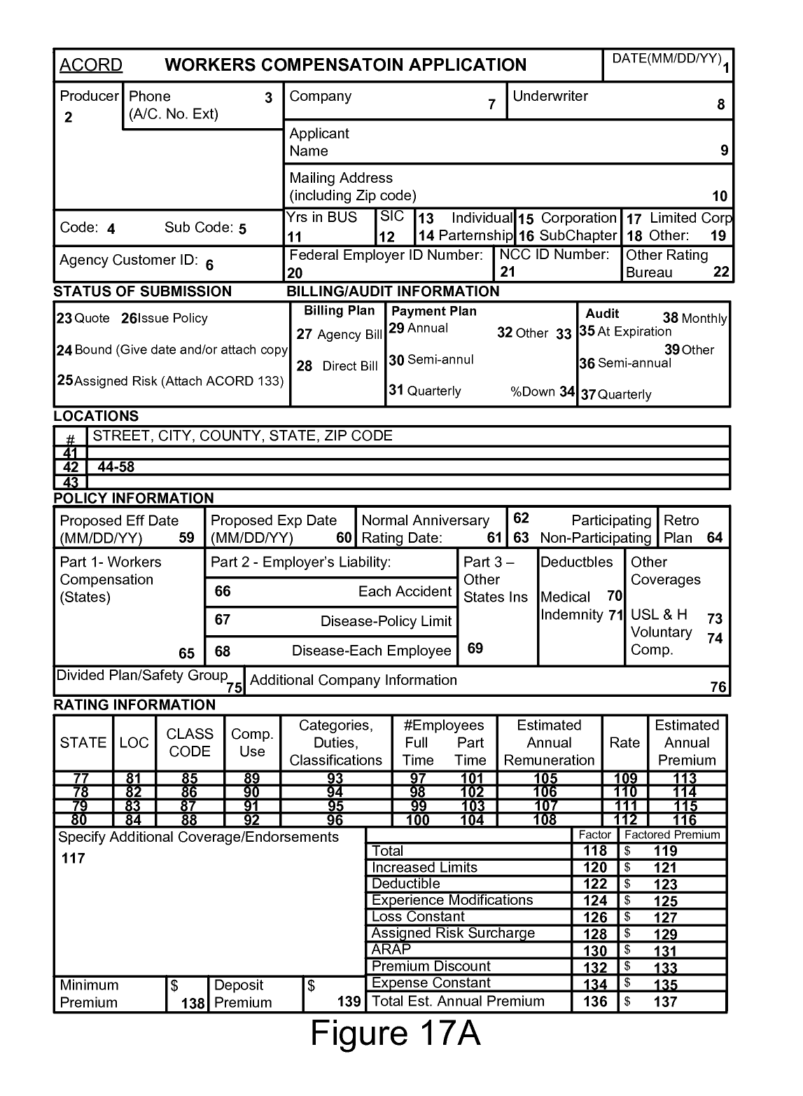

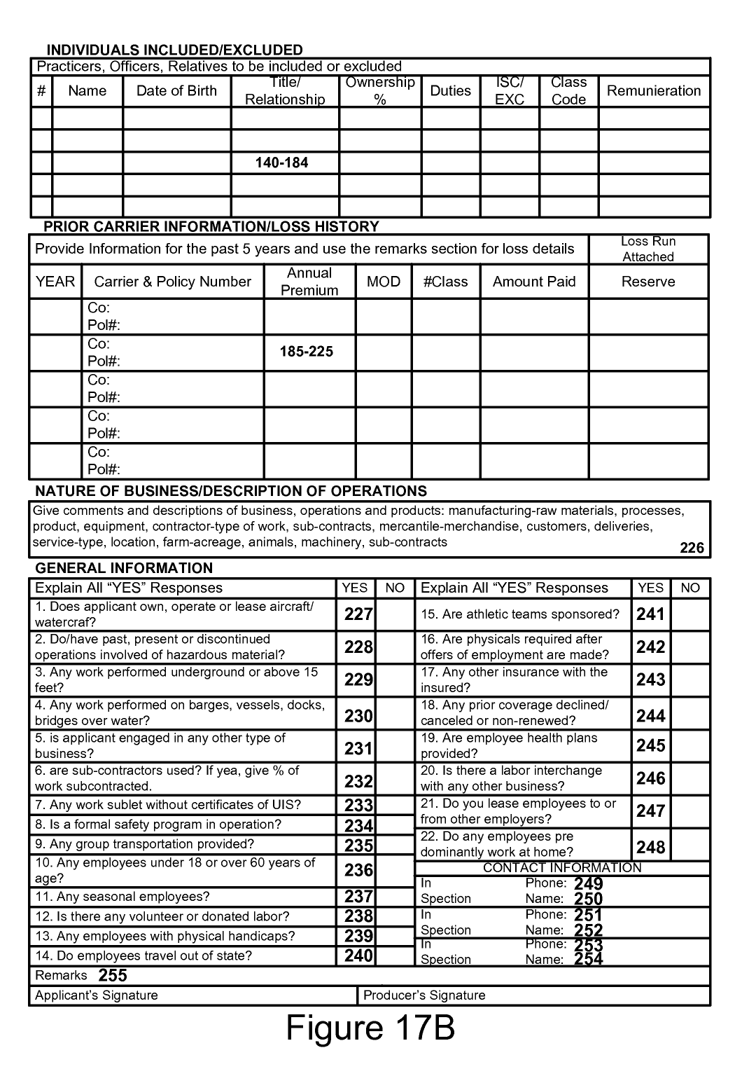

The form list builder 316 is coupled to the program application module 304, the insurer data storage 322, and the form and completed form data storage 320 and the database interface module 310 by the bus 212. The form list builder 316 is responsive to the program application module 304. The form list builder 316 is responsible for list of supplemental form that must be provided to each insurer beyond the basic ACORD form. The ACORD form provides much of the standard data required, and an example is shown in FIGS. 17A and 17B. Additionally, a mapping between the ACORD form and fields used by the present invention is detailed below in Appendix A. The form list builder 316 accesses the insurer data storage 322 to retrieve the data regarding available insurers, and the form and completed form data storage 320 to retrieve the forms corresponding to each insurer. The form list builder 316 and may also accesses the database 170 via the database interface module 310 if the information is not present in the insurer data storage 322 or the form and completed form data storage 320. The form list builder 316 may also store the data in working memory (not shown) for use in later operations by the application program 304. The form list builder 316 also interacts with the agent/user interface module 312 to present available insurer to the user for selection as shown in FIG. 10.

The bus 212 couples the form completion module 318 to the program application module 304, and the insurer system interface module 308. The form completion module 318 is responsive to the program application module 304. The form completion module 318 is responsible for assembling data input by the user and retrieved from the risk information system 104 into discrete application units that can be provided to each respective insurer by the insurer system interface module 308. More particularly, the form completion module 318 selects sets of data for transmission to the insurer system interface module 308.

The form and completed form storage 320 is portion of memory 216A used to store various forms required by the insurers. A first part of the memory 216A stores forms that identify the data required. The forms essentially encapsulate groups of information that may be used by the insurers in underwriting the policy. A second portion of memory 216A is used as working memory to store completed forms—in other words, the form plus data input by the user for the fields presented by the form. These completed forms may then be selected and grouped according to the requirements of each insurer.

Similarly, the insurer data storage 322 is a portion of memory used to store information about each insurer. For example, the insurer address for communication and submission of an application, the data required for a complete application, the formatting of the application and other related to an insurer. The insurer data storage 322 is used by the program application 304, and other modules to gather appropriate data and communicate with insurer systems 106. Those skilled in the art will recognize that that the insurer data storage 322 and the form and completed form storage 320 may include databases and similar functionality, and may alternately be portions of the data storage device 218.

B. Risk Information Server

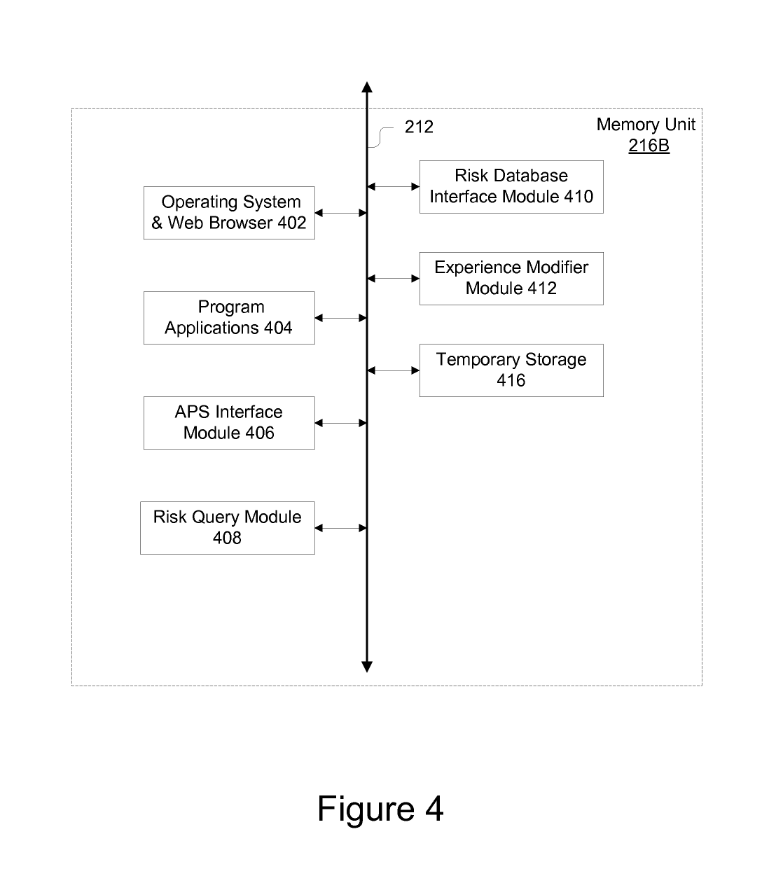

FIG. 4 illustrates another embodiment of the memory 216B constructed according to the present invention. The memory 216B is preferably configured for the server 184 of the risk information system 104. The memory 216B preferably includes an operating system and web browser 402, program applications 404, an APS interface module 406, a risk query module 408, a risk database interface module 410, an experience modifier module 412 and temporary storage 416.

The memory 216B preferably includes an operating system and web browser 402. For example, the operating system may be WINDOWS®, UNIX® or LINUX® based operating systems. The web browser may be Microsoft Explorer or Netscape Navigator.

The modules 406, 408, 410, and 412 are coupled to a program application module 404 by the bus 212. The program application module 404 is also coupled to other components of the server 184 by the bus 212. The program application module 404 serves as the central interface between the other elements of the server 184 and the modules 406, 408, 410, and 412. In one embodiment of the invention, the server 176 receives requests to perform an editing, query or storage function through the keyboard 204, mouse 206, or some other type of computing device. The program application module 404 interprets the input and activates the appropriate module 406, 408, 410, and 412. While the discussion focuses primarily on the operation of the program application module 404 as it relates to the electronically creating, filing and approving applications, those skilled in the art will realize that he program applications can include other applications that are not fully detailed here. The program application module 404 retrieves the relevant data from application processing system 102 and passes it to the appropriate module 406, 408, 410, and 412. The respective modules 406, 408, 410, and 412 modify the data and return it to the application module 404.

The bus 212 couples the APS interface module 406 to the program application module 404 and the network controller 208. The APS interface module 406 is responsive to the program application module 404. The APS interface module 406 is responsible for communication with application processing system 102. The APS interface module 406 communicates with application processing system 102 to send risk data need to complete the insurance application form. For example, the APS interface module 406 is responsive to queries made to extract risk data to populate the basic form as well as supplemental forms required by the insurer. The APS interface module 406 may also be used to retrieve data about the applicant in the risk information system 104. The APS interface module 406 is responsible for communicating and interacting with the application processing system 102, in particular the risk system interface module 306, to provide this information to the program application module 304.

The risk query module 408 is coupled to the program application module 404 and the risk database interface module 410. The risk query module 408 is responsive to the program application module 404. The risk query module 408 cooperates with the risk database interface module 410 to perform queries on the risk database 180. In particular, the risk query module 408 translates commands, request, and data from the application processing system 102 so that they may be used on the risk database 180. The risk query module 408 may also be used to return data to the program application module 404 or it may be returned directly by the risk database interface module 410.

The risk database interface module 410 is coupled to the program application module 404 and the network controller 208 by the bus 212. The risk database interface module 410 is responsive to the program application module 404. The risk database interface module 410 is responsible for communication with database 180 that forms a portion of the risk information system 104. The risk database interface module 410 is responsible for storing data to and retrieving data from the database 180. This may include a variety of applicant data, risk data, and historical data. The database interface module 410 is coupled via the network controller 208 to the database 180.

The experience modifier module 412 is coupled to the bus 212 for interaction with the program application module 404. The experience modifier module 412 modifies the rating data retrieved from the insurer system 106 using various algorithms known to those skilled in the art. For example, the rating data is modified above or below a unity value according to the historical loss record of the applicant relative to the industry norm. Factors included in this calculation include job type, salary, historical loss and established rate as set by states or competitive practices. The experience modifier module 412 receives data from the program application module 404, modifies it and the returns it to the program application module 404 for addition to the application. The server also include temporary storage 416 for storing data while in use by the program application module 404 and other modules 406, 408, 410 and 412. As has been noted above, the risk information system 104 may be a system such as Compline® manufactured and operated by Data Control Corporation of Grass Valley, Calif.

C. Insurer Server

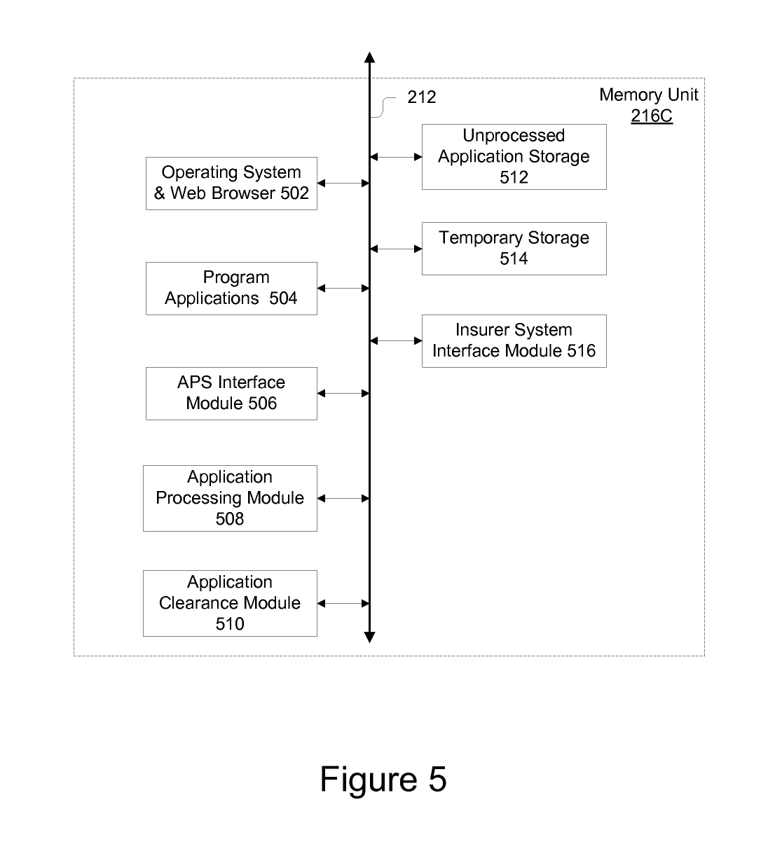

FIG. 5 illustrates yet another embodiment of the memory 216C constructed according to the present invention. The memory 216C is preferably configured for the server 150 of the insurer system 106. The memory 216C preferably includes an operating system and web browser 502, program applications 504, an APS interface module 506, an application processing module 508, an application clearance module 510, unprocessed application storage 512, temporary storage 514, and an insurer system interface module 516.

The memory 216C preferably includes an operating system and web browser 502. For example, the operating system may be WINDOWS®, UNIX® or LINUX® based operating systems. The web browser may be Microsoft Explorer or Netscape Navigator.

The modules 506, 508, 510, and 516 are coupled to a program application module 504 by the bus 212. The program application module 504 is also coupled to other components of the server 150 by the bus 212. The program application module 504 serves as the central interface between the other elements of the server 150 and the modules 506, 508, 510, and 516. In one embodiment of the invention, the server 150 receives requests to accept, process or update status on an application for insurance coverage from some other type of computing system. The program application module 504 interprets the input and activates the appropriate module 506, 508, 510, and 516. While the discussion focuses primarily on the operation of the program application module 504 as it relates to the electronically filing and approving applications, those skilled in the art will realize that he program applications can include other applications that are not fully detailed here. The program application module 504 retrieves the relevant data from application processing system 102 and passes it to the appropriate module 506, 508, 510, and 516. The respective modules 506, 508, 510, and 516 analyze the data and return indication of the terms for the insurance policy.

The bus 212 couples the APS interface module 506 to the program application module 504 and the network controller 208. The APS interface module 506 is responsive to the program application module 504. The APS interface module 506 is responsible for communication with application processing system 102. The APS interface module 506 communicates with application processing system 102 to receive an application for processing and communicates regarding the processing of the application such as status, acceptance, rejection, or request for more information. The APS interface module 506 is responsible for communicating and interacting with the application processing system 102, in particular the insurer system interface module 308, to provide this information to the program application module 304. The APS interface module 506 is also coupled to the unprocessed application storage 512 to store application received therein.

The application-processing module 508 is coupled to the program application module 504, the unprocessed application storage 512, and the insurer system interface module 516. The application-processing module 508 is responsible for the processing of the application internal to the insurer system 106. The application-processing module 508 is responsive to calls from the program application module 504. In response, the application-processing module 508 retrieves unprocessed applications from the unprocessed application storage 512 and provides them to the insurers system 106 using the insurer system interface module 516. The application-processing module 508 is also responsible for tracking the application, calling other routines such as the application clearance module 510, and communicating application status to the user via the APS interface module 506.

The application clearance module 510 is coupled to the application processing module 508 and the insurer system interface module 516. The application clearance module 510 is responsive to the application-processing module 508. The application clearance module 510 determines whether the agent submitting the application for insurance has territorial coverage for the area of the insured. The application clearance module 510 may also provide redundancy checking to make sure that another agent has not already submitted the application for the insured. The application clearance module 510 cooperates with the insurer system 106 using the insurer system interface module 516 to make these determinations.

The memory 216C also includes unprocessed application storage 512 and temporary storage 514. The unprocessed application storage 512 is an area where other systems may submit electronic applications for processing by the insurer system 106. The unprocessed application storage 512 is preferably a FIFO queue for storing unprocessed applications. The memory 216C also include a temporary storage area 514 for storing data used in various processes, and for pending communications.

The insurer system interface module 516 is coupled to the program application module 504 and the insurer system 106. The insurer system interface module 516 is responsive to the program application module 504. The insurer system interface module 516 cooperates with the mainframe computer 152 to process the application according to processes prescribed by the insurer. The insurer system interface module 516 is also able to interact with the underwriting workstations 154 via the network 158 or the mainframe computer 152. The insurer system interface module 516 translates data and commands between the mainframe computer 152 and the program application 504.

While each of the servers 176, 150, 184 have been described above as having particular modules as described for memories 216A, 216B, 216C, those skilled in the art will recognize that this functionality may alternatively be distributed to other servers with these systems 102, 104 106, such as the database servers 170 and 180, and the module and their organization are provided only by way of example.

### 3. Methods

Referring now to FIG. 6, a first embodiment of the method for creating, filing and approving applications for insurance coverage will be described. The method begins by receiving 600 application data. This preferably done by a user at an agent terminal 110, and the data is sent to the application processing system 102. Then the application processing system 102 accesses 602 the risk information system 104 and retrieves risk data corresponding to the application data input in step 600. Then the application processing system 102 determines 604 the insurers to which the application should be submitted. This is preferably done by presenting a user interface on the agent terminal 110 and allowing the user to input her choice. Next, the application processing system 102 prepares 606 one or more applications. Based on the insurers determined in step 604, the application processing system 102 prepares an application for each insurer selected. Each insurer may require different data, thus, for each insurer the application processing system 102 prepares an application with the information they require in the format they have prescribed. Then the applications are sent 608 from the application processing system 102 to the insurer systems 106 by email or some similar electronic form. A particular advantage of the present invention is the elimination of paper handling, and the elimination of the need to key in information by the insurer. Once the application has been received at the insurer system 106, it is processed 610 by the insurer system 106. As has been noted above, the insurer system 106 will process the application, performing a variety of tests and inquiries. Finally, the insurer system 106 communicates 612 with the agent terminal 110 via the application processing system 102. The communication can be a request for additional information or clarification of information, a rejection of the application, a cancellation of the application, an acceptance of the application or communication of information such as assignment of an underwriter to the application.

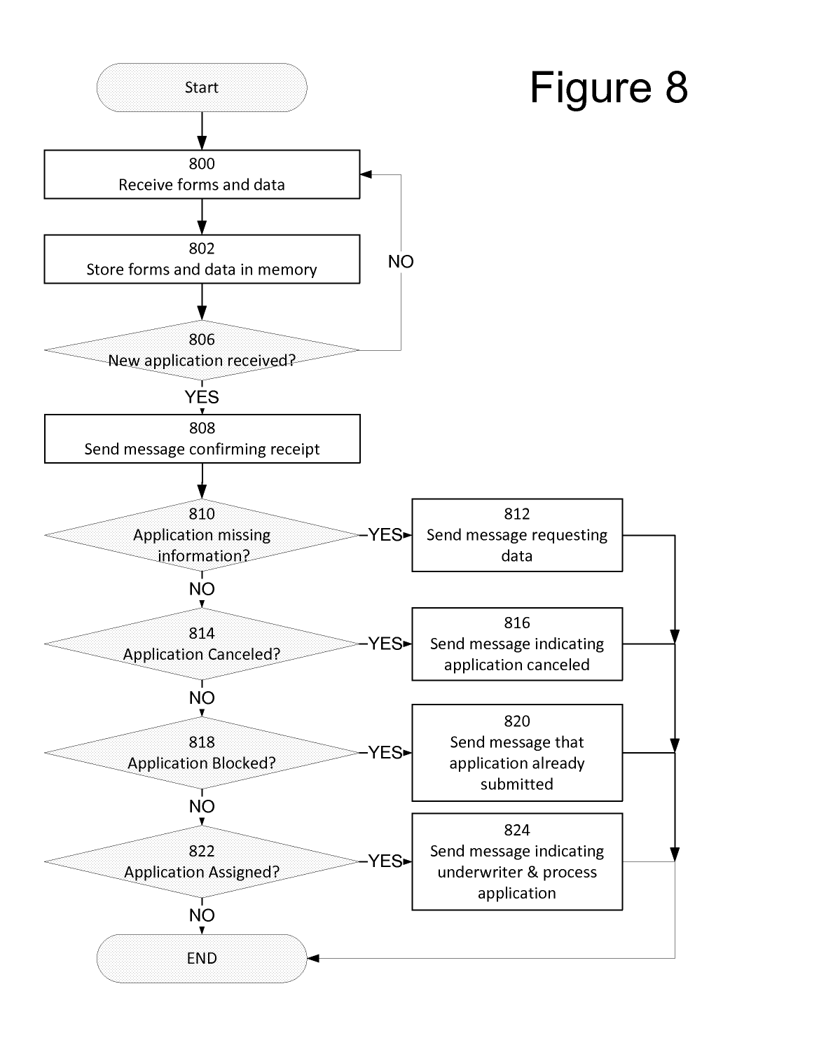

Referring now to FIGS. 7A-7C and 8, a second more detailed embodiment of the method for creating, filing and approving applications for insurance coverage will be described. The process begins by presenting 700 a user interface 900 on the agent terminal 10. A graphical representation of a screen showing one such exemplary user interface 900 is shown in FIG. 9. The user interface 900 allows the user to input data necessary to complete an application for insurance. Then the user inputs data from the agent terminal 10. The input data is received 702 and transmitted from the agent terminal 10 to the application processing system 102. The method next determines 706 whether the user has input a command to submit a risk. This can be done by double clicking on a hypertext link 902 in the user interface 900 or by selecting a “submit risk” button 904. If the user has decided not to submit a risk, the process loops through step 700 to continue to display the user interface 900 and step 702 to accept input data.

Once the user has decided to submit a risk or submit an application, the process continues to step 708. In step 708, the method determines whether the user is authorized to submit a risk. For example, a database 170 containing information about the user (producer or agent) is consulted. If the user is authorized to input a submission, the application continues to step 710; otherwise the process ends. Next, the application processing system 102 creates 710 a list of possible destinations for the user. The application processing system 102 examines the available destinations and selects all those destinations to which this user or producer is allowed to submit applications. This list of possible destinations is presented to the user, via a web page. An exemplary web page 1000 is shown in FIG. 10, with an exemplary list 1002. Using this web page 1000 the user can select the destination or destinations to which he wishes to make a submission. The selected destinations are indicated with a marked check box. The application processing system 102 then retrieves 712 the destination data and determines or builds 714 a list of necessary forms for all destinations. As discussed above this may be done with the destination builder 314 of the application-processing server 176. To eliminate duplication, the application processing system 102 advantageously requires only one form be filled out even if it is to be submitted to multiple destinations. In all cases, there are core forms that must be submitted to every destination. These core or necessary forms are retrieved 716 from the database 170 or from form and data storage 320 if they are stored there.

Once the core forms have been retrieved, the process continues to retrieve the risk data from the risk information system 104. The risk data is retrieved and added to the core forms in the proper locations. For example, all applicable information that is available may be pre-filled into the screen, such as the Producer Name, Applicant Name/Address, Bureau Id, and Class Codes. The risk of data is consulted and the core forms are populated with that information which the application processing system 102 has on that risk for this form. The core form(s) are then displayed 722 sequentially with the pre-populated data in them. The user is allowed to enter data into fields that are blank and to correct any pre-populated fields. The application processing system 102 determines whether the user has input more data. If more data has been input, the information is received 726 and inserted into the form, and the process returns to step 722 to display the form updated with the additional data. If there is no more information to be added, the forms including the data therein are stored 728 as completed forms in the form data storage 320.

Next, the application processing system 102 determines whether there are any supplementary forms required for the destination selected in step 712. If so, the next form is retrieved 734 and populated with known data, thereby illuminating duplicate entries. FIG. 10 also shows one embodiment for providing supplemental information. In particular, the area 1004 below the selected destinations 1002 is an interface through which supplemental data can be input. The risk data for the form is again retrieved, and once more, the user is allowed to fill in additional information as the process loops through steps 718, 720, 722, 724 and 726 for the supplemental form. This process is repeated for each supplemental form required until there are no more supplemental forms to be retrieved. Once the last supplemental form has been completed and stored, the process transitions to step 736.

Once the last supplemental form has been filled out and saved the process of transmitting the forms to the insurer begins. For each destination, the forms necessary for that destination are identified 740 and selected. The form(s) are then converted 742 into a format compatible with the requirements of the destination. The form is then transmitted to the destination. Then the method test whether are more destinations for this application. If so, the method returns to step 742 to format and transmit the forms to each destination. If the forms have been transmitted to all require destinations then process ends. Separating the format of the forms from the transmittal format allows multiple destinations, having different format requirements for each transmission, to be accommodated. The user is totally unaware of the fact that differing destinations have differing requirements bolt in terms of which forms must be filled out and what format the forms are transmitted. If the user wishes to retain a copy of the application, they will need to print a copy before sending it to the insurer system 106. Any subsequent copies will be obtained by requesting a fax copy of the quote from the insurer. A copy of every completed application can be stored in the application processing system 102 archived by user, with a bureau number and date stamp in case there are multiple versions.

Referring now to FIG. 8, the method for processing the applications at the insurer system 106 is described in more detail. The process begins when a new application having the requisite forms and data is received by the insurer system 106. The forms and data are then stored memory 216C. Each insurer will define the method they will use to receive the application data. The translation and migration of the data to the insurers internal quoting systems will be designed and built on a case-by-case basis. It should be understood that these first two steps could be asynchronous with respect to the further processing of the application. These steps are initiated whenever a new electronic application is received from the application processing system 102 or alternatively from the risk information system 104 such as Compline®. After the data is received and is verified as a correct transmission by transmission protocols associated with the Internet 108, the data is then placed in the database of applications to be processed with a flag indicating that it is an electronic submission via the application processing system 102.

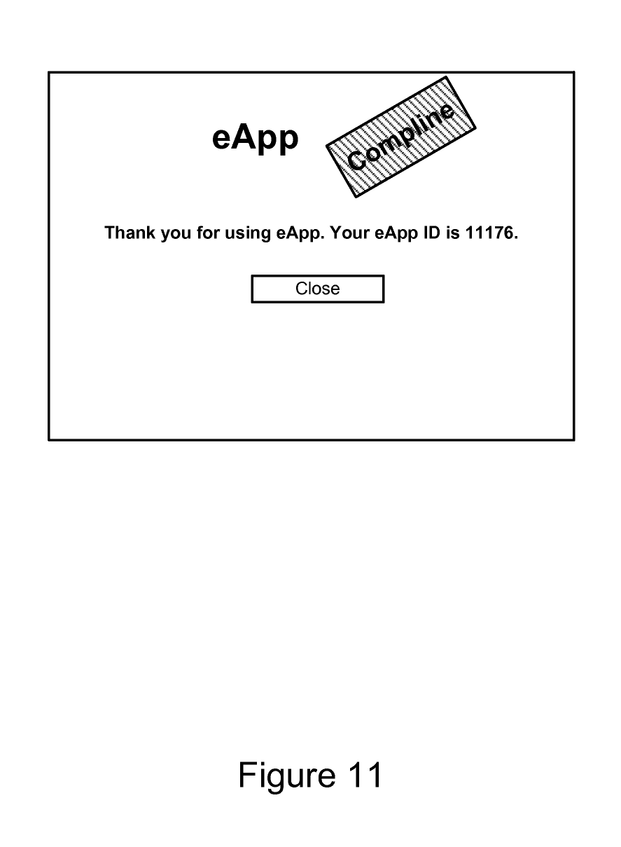

At the same time as new, unprocessed applications are added to the database server 150, the insurer system 106 determines 806 whether there are any new applications received. If not the process returns to steps 800 and 802 to await delivery of new applications. If an application has been received, the process sends 808 a confirmation message including a reference number. An exemplary confirmation message is shown in FIG. 11. The user preferably also receives a confirmation message via e-mail informing them that the application has been received by the selected insurer(s). The confirmation message may include a reference number, the user's name, and e-mail address, the insurers office name, phone number, and address. It will also contain the applicant's name, phone number and, address information. Each Carrier will be able to specify its message(s) in various circumstances.

In an alternate embodiment, the determining 806 may be performed on a timed the basis. In such an embodiment, the insurer system 106 scans the database server 150 for newly submitted applications. When it finds an application that has been submitted since the last time it ran it prepares that application for processing by taking the steps that would normally be done during manual entry of the application. These may include but are not limited to, consulting internal databases to verify that an authorized agent or producer submitted the application and that all fields are filled out correctly. Once this has been done, the application enters the insurers internal system as if it had been manually input. During the process of examining the application, within the underwriting process, an electronic version all the original application is available so that fields in the application may be verified. More specifically, the insurer system 106 may perform a number of tests on the electronic application that has been received, and send corresponding notification to the user. Exemplary notifications are shown in Appendix B. In step 810, the method determines whether there is any missing information from the application. If so, the insurer system 106 sends 812 a message requesting additional information to the user, and then stops processing the application. If the application is complete, the insurer system 106 determines whether the application has been canceled. If so, the insurer system 106 sends 816 a message requesting indicating the application has been canceled and then stops processing the application. If the application has not been canceled, the method continues to determine 818 if the application should be blocked. If the application should be blocked because another user has already submitted it, the insurer system 106 sends a message indicating the application has already been submitted by another and ends. If the application is not blocked, the method tests whether the application has been assigned. If not, the process is complete. If so, a message is sent to the user indicating the underwriter and the status of the application. Those skilled in the art will recognize that the tests 810, 814, 818 and 822 and messaging steps 812, 816, 820 and 824 are provided only by way of example, and that such processing of the application may have any number of different steps according to the internal processes of the insurer.

### 4. User Interface

One key aspect of the present invention is the user interface provided to interact with the application processing at various stages. These user interfaces also allow the data to be modified to correct any inaccuracies based on retrieval form the risk information system 104.

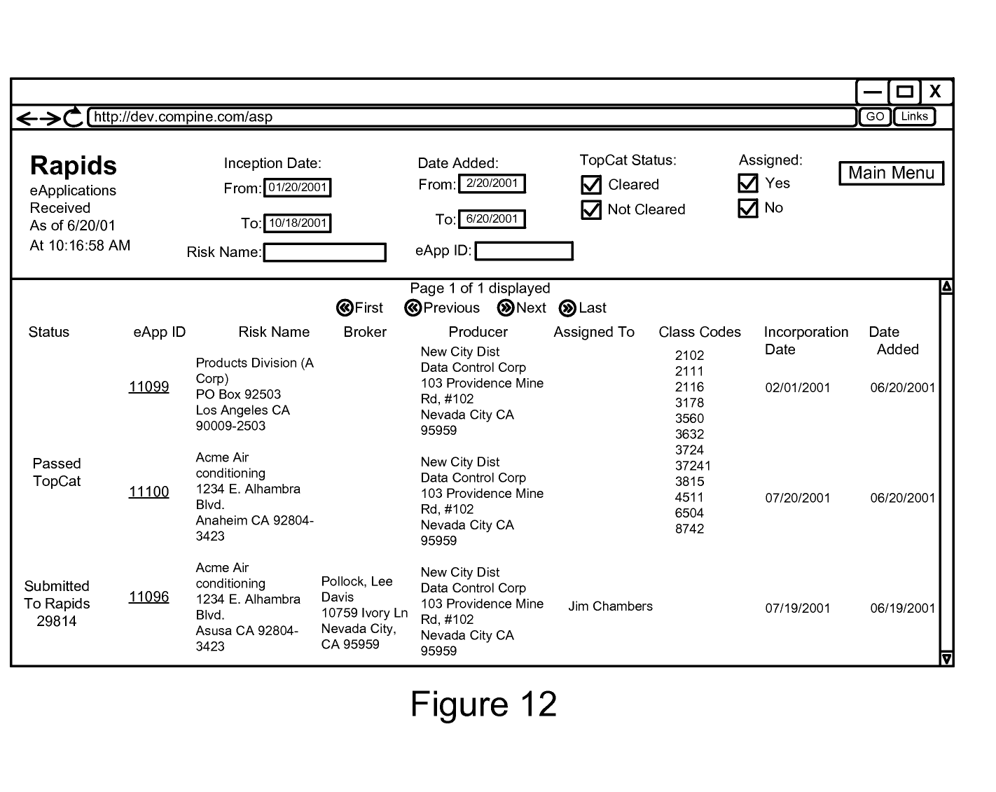

For example, FIG. 12 illustrates a user interface of the present invention for reviewing an application once the insurer has received it. The user interface can display multiple application submitted. The UI advantageously display the Status, Reference Number, Risk Name, Broker Name, Producer Name, Assigned-To name (if assigned), Inception Date, and Date Added in an easy to read format. Data can be selected based on Inception Date or Date Added, if clearance status has cleared or not, and whether the electronic application has been Assigned or not. Users can also search by Risk Name and electronic application Identification number.

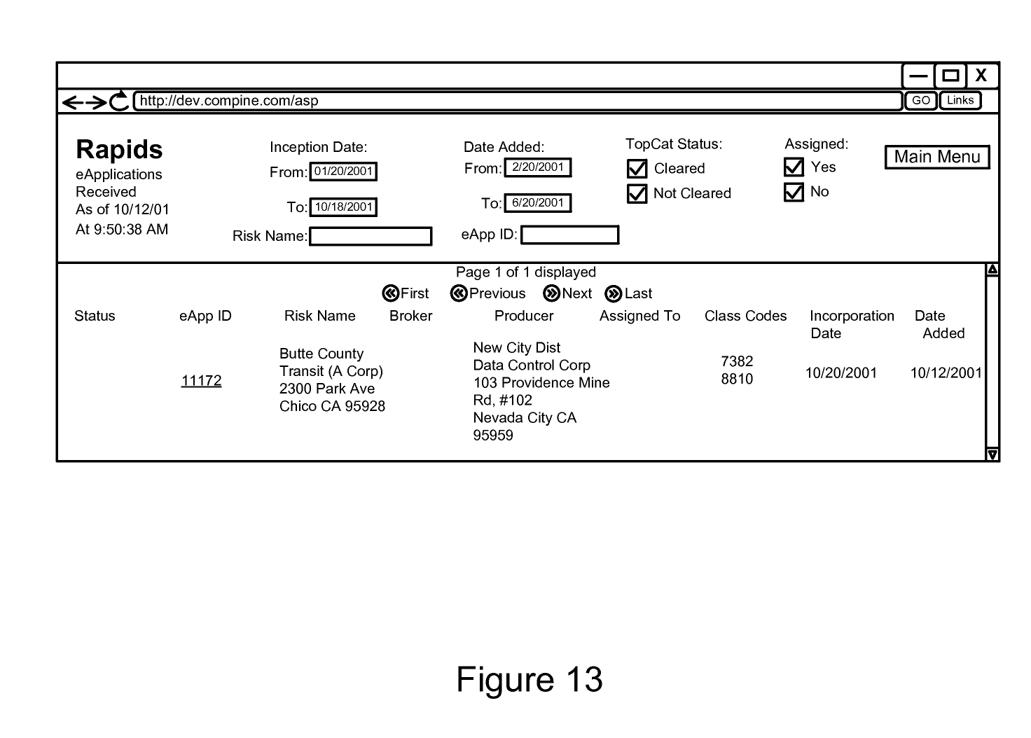

FIG. 13 illustrates a user interface of the present invention for reviewing applications including a drop down list of available clearance users from that district will be displayed under the stop sign. The user can select a user from the list, click the stop sign, and E-mail will be sent to a person within the clearance rights requesting that they clear the electronic application.

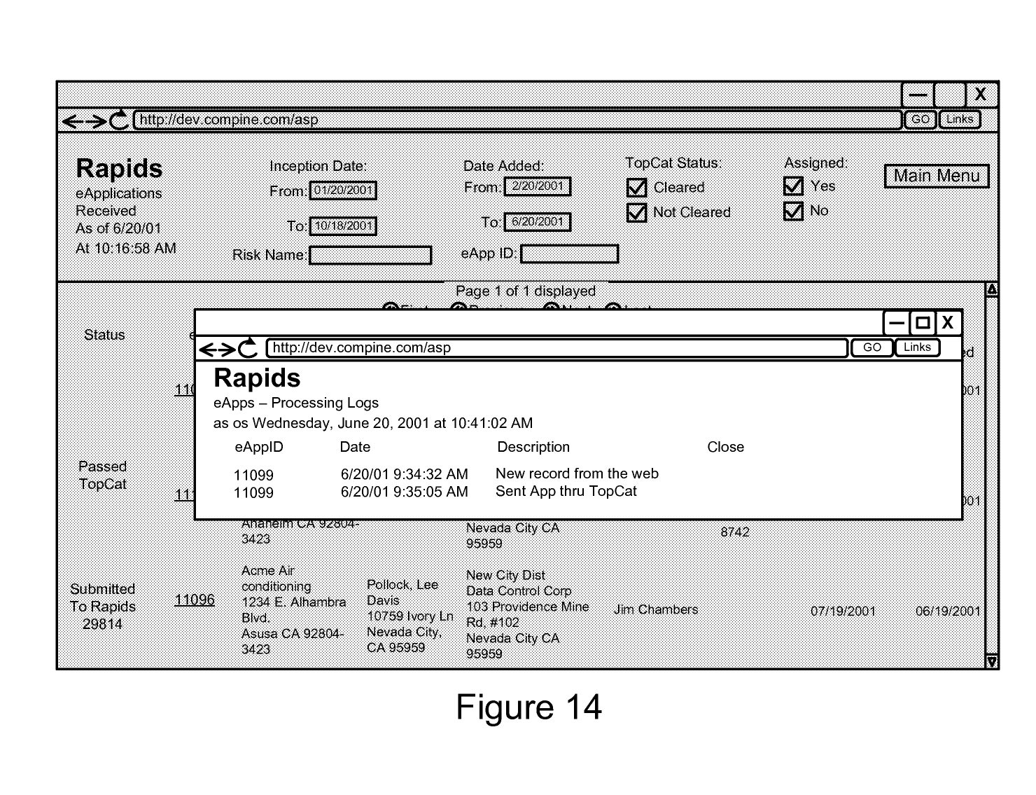

FIG. 14 illustrates a graphical representation of a preferred embodiment of the user interface for displaying a processing log. The UI of FIG. 14 allows an administrator to view the entries for an electronic application. Log entries can include the following items: new record from the web, sent application thru clearance, application cleared, broker and/or user updated in database, submitted insurer system, broker and/or user updated in clearance database, application set to dead in clearance, application status set to cancelled.

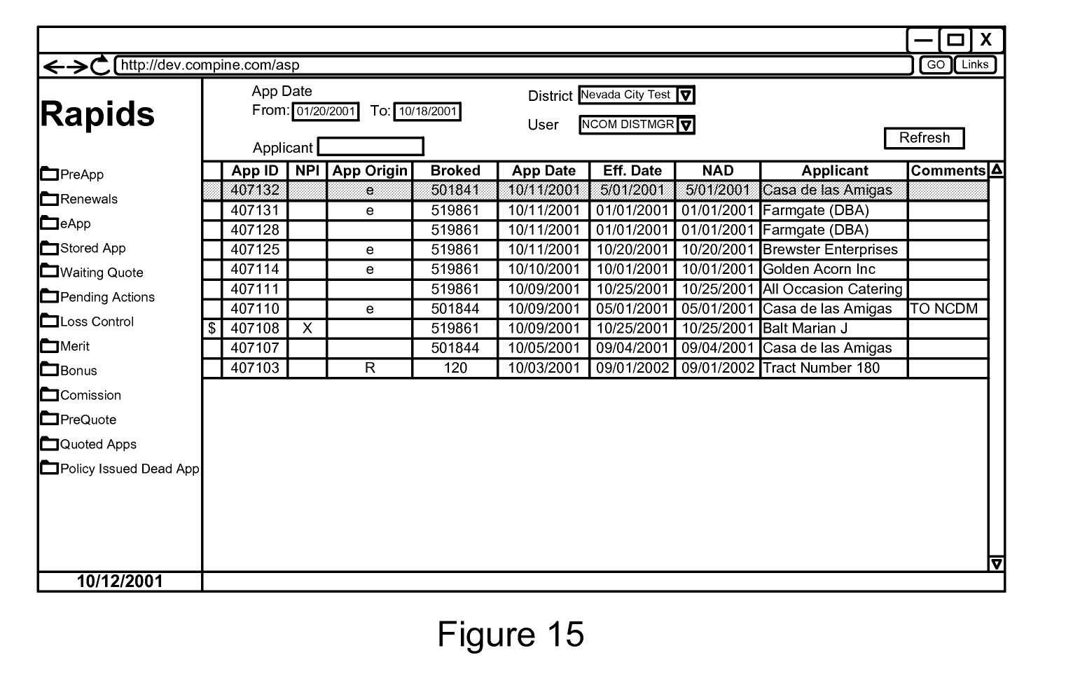

FIG. 15 is a graphical representation of a preferred embodiment of the user interface for showing assigned and unassigned electronic applications. This UI is advantageous because of the ease at which new applications can be distinguished from renewals.

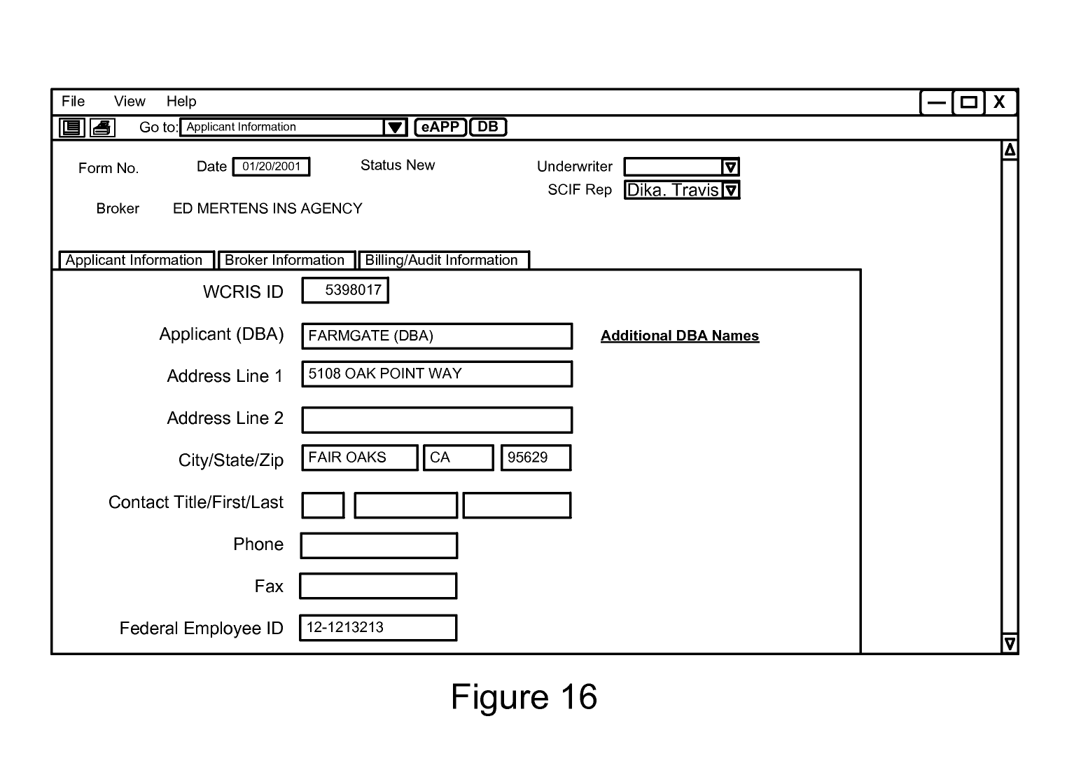

FIG. 16 is a graphical representation of a preferred embodiment of the user interface for modifying the data in an electronic application. This window may be displayed at various times to the user, and provides an easy to use mechanism for the user to update, correction or add information to an electronic application.

While the present invention has been described with reference to certain preferred embodiments, those skilled in the art will recognize that various modifications may be provided. For example, there may be a variety of other mechanism that may be included as part of the user interface to enable the functionality that has been described above. Variations upon and modifications to the preferred embodiments are provided for by the present invention, which is limited only by the following claims.

### APPENDIX A

The following table defines the mapping between the ACORD form and the database tables of the application processing system 102.

| Number | Form Sub Section | Form Data Item | Database | Table | Field |
|---|---|---|---|---|---|
| 1 | None | Date (MM/DD/YY) | Rapids | Rapids | RapidsDate |
| 2 | Agency | Producer | Rapids | Broker | AgencyTitle, AgencyLast, |
| | | | | | AgencyFirst |
| 3 | Agency | Producer Phone | | | |
| 4 | Agency | Code | | | |
| 5 | Agency | Sub Code | | | |
| 6 | Agency | Agency Customer ID | | | |
| 7 | Applicant | Company | | | |
| 8 | Applicant | Underwriter | Rapids | Rapids | UnderwriterID |
| 9 | Applicant | Applicant name | | | AppName |
| 10 | Applicant | Mailing Address (including | | | AppAddress1, AppAddress2, |
| | | Zip Code) | | | City, State Zip |
| 11 | Applicant | Yrs in Bus | | | YrsInBus |
| 12 | Applicant | SIC | | | |
| 13 | Applicant | Individual | Rapids | Applicant | LegalEntityId |
| 14 | Applicant | Partnership | | | |
| 15 | Applicant | Corporation | | | |
| 16 | Applicant | Subchapter “S” Corp | | | |
| 17 | Applicant | Limited Corp | | | |
| 18 | Applicant | Other | | | |
| 19 | Applicant | Other: (Description) | | | |
| 20 | Applicant | Federal Employer ID | | | FederalEmployerID |
| | | Number | | | |
| 21 | Applicant | NCCI ID Number | | | |
| 22 | Applicant | Rating Bureau ID | Rapids | Rapids_Policy_Info | WCIRBID |
| 23 | None | Quote | | | |
| 24 | None | Issue Policy | | | |
| 25 | None | Bound (Give Date or | | | |
| | | Attach Copy) | | | |
| 26 | None | Assigned Risk | | | |
| 27 | Billing Plan | Agency Bill | Rapids | Rapids_Billing_Audit_Info | BillingPlan |
| 28 | Billing Plan | Direct Bill | Rapids | Rapids_Billing_Audit_Info | BillingPlan |
| 29 | Payment Plan | Annual | Rapids | Rapids_Billing_Audit_Info | PaymentPlan |
| 30 | Payment Plan | Semi-Annual | Rapids | Rapids_Billing_Audit_Info | PaymentPlan |
| 31 | Payment Plan | Quarterly | Rapids | Rapids_Billing_Audit_Info | PaymentPlan |
| 32 | Payment Plan | Other | Rapids | Rapids_Billing_Audit_Info | PaymentPlan |
| 33 | Payment Plan | Other: (Description) | Rapids | Rapids_Billing_Audit_Info | PaymentPlan |
| 34 | Payment Plan | % Down: | Rapids | Rapids_Billing_Audit_Info | PaymentPlan |
| 35 | Audit | At Expiration | Rapids | Rapids_Billing_Audit_Info | Audit |
| 36 | Audit | Semi-Annual | Rapids | Rapids_Billing_Audit_Info | Audit |
| 37 | Audit | Quarterly | Rapids | Rapids_Billing_Audit_Info | Audit |
| 38 | Audit | Monthly | Rapids | Rapids_Billing_Audit_Info | Audit |
| 39 | Audit | Other | Rapids | Rapids_Billing_Audit_Info | Audit |
| 40 | Audit | Other: (Description) | Rapids | Rapids_Billing_Audit_Info | Audit |
| 41 | None | # 1 | | | |
| 42 | None | # 2 | | | |
| 43 | None | # 3 | | | |
| 44 | None | Street 1 | Rapids | APP_ADDRESS | |
| 45 | None | Street 2 | Rapids | APP_ADDRESS | |
| 46 | None | Street 3 | Rapids | APP_ADDRESS | |
| 47 | None | City 1 | Rapids | APP_ADDRESS | |
| 48 | None | City 2 | Rapids | APP_ADDRESS | |
| 49 | None | City 3 | Rapids | APP_ADDRESS | |
| 50 | None | County 1 | Rapids | APP_ADDRESS | |
| 51 | None | County 2 | Rapids | APP_ADDRESS | |
| 52 | None | County 3 | Rapids | APP_ADDRESS | |
| 53 | None | State 1 | Rapids | APP_ADDRESS | |
| 54 | None | State 2 | Rapids | APP_ADDRESS | |
| 55 | None | State 3 | Rapids | APP_ADDRESS | |
| 56 | None | Zip Code 1 | Rapids | APP_ADDRESS | |
| 57 | None | Zip Code 2 | Rapids | APP_ADDRESS | |
| 58 | None | Zip Code 3 | Rapids | APP_ADDRESS | |
| 59 | None | Proposed Effective Date | Rapids | Rapids_Policy_Info | EffDate |
| 60 | None | Proposed Expiration Date | Rapids | Rapids_Policy_Info | ExpDate |
| 61 | None | Normal Anniversary Rating | Rapids | Rapids_Policy_Info | AnniversaryDate |
| | | Date | | | |
| 62 | None | Participating | Rapids | Rapids_Policy_Info | Participating |
| 63 | None | Non-Participating | | | |
| 64 | None | Retro Plan | | | |
| 65 | Part 1 | Workers' Comp (States) | | | |
| 66 | Part 2-Employers | Each Accident | Rapids | Rapids_Policy_Info | LimitEachAccident |
| | Liability | | | | |
| 67 | Part 2-Employers | Disease-Policy Limit | Rapids | Rapids_Policy_Info | LimitDiseasePolicyLimit |
| | Liability | | | | |
| 68 | Part 2-Employers | Disease-Each Employee | Rapids | Rapids_Policy_Info | LimitDiseaseEachEmp |
| | Liability | | | | |
| 69 | Part 3 | Other States Ins | | | |
| 70 | Deductibles | Medical | | | |
| 71 | Deductibles | Indemnity | | | |
| 72 | None | Amount/% | | | |
| 73 | Other Coverages | U.S.L. & H. | Rapids | Rapids_Policy_Info | USLH |
| 74 | Other Coverages | Voluntary Compensation | Rapids | Rapids_Policy_Info | VolComp |
| 75 | None | Dividend Plan/Safety Group | Rapids | Rapids_Policy_Info | SafetyGroupId |
| 76 | None | Additional Company | Rapids | Rapids_Policy_Info | AdditionalColnf |
| | | Information | | | |
| 77 | None | State1 | | | |
| 78 | None | State2 | | | |
| 79 | None | State3 | | | |
| 80 | None | State4 | | | |
| 81 | None | Loc1 | Rapids | Rapids_CLASS | LocNo |
| 82 | None | Loc2 | | | |
| 83 | None | Loc3 | | | |
| 84 | None | Loc4 | | | |
| 85 | None | Class Code 1 | Rapids | Rapids_CLASS | ClassCD |
| 86 | None | Class Code 2 | | | |
| 87 | None | Class Code 3 | | | |
| 88 | None | Class Code 4 | | | |
| 89 | None | Company Use 1 | | | |
| 90 | None | Company Use 2 | | | |
| 91 | None | Company Use 3 | | | |
| 92 | None | Company Use 4 | | | |
| 93 | None | Categories, Duties, | SCIFCommon | Class | Description |
| | | Classifications 1 | | | |
| 94 | None | Categories, Duties, | | | |
| | | Classifications 2 | | | |
| 95 | None | Categories, Duties, | | | |
| | | Classifications 3 | | | |
| 96 | None | Categories, Duties, | | | |
| | | Classifications 4 | | | |
| 97 | None | # Employees Full Time 1 | Rapids | Rapids_CLASS | NoEmployee |
| 98 | None | # Employees Full Time 2 | Rapids | Rapids_CLASS | NoEmployee |
| 99 | None | # Employees Full Time 3 | Rapids | Rapids_CLASS | NoEmployee |
| 100 | None | # Employees Full Time 4 | Rapids | Rapids_CLASS | NoEmployee |
| 101 | None | # Employees Part Time 1 | Rapids | Rapids_CLASS | NoEmployee |
| 102 | None | # Employees Part Time 2 | | | |
| 103 | None | # Employees Part Time 3 | | | |
| 104 | None | # Employees Part Time 4 | | | |
| 105 | None | Estimated Annual | Rapids | Rapids_CLASS | Renumeration |
| | | Renumeration 1 | | | |
| 106 | None | Estimated Annual | Rapids | Rapids_CLASS | Renumeration |
| | | Renumeration 2 | | | |
| 107 | None | Estimated Annual | Rapids | Rapids_CLASS | Renumeration |
| | | Renumeration 3 | | | |
| 108 | None | Estimated Annual | Rapids | Rapids_CLASS | Renumeration |
| | | Renumeration 4 | | | |
| 109 | None | Rate 1 | SCIFCommon | Class | BaseRate |
| 110 | None | Rate 2 | | | |
| 111 | None | Rate 3 | | | |
| 112 | None | Rate 4 | | | |
| 113 | None | Estimated Annual | 113 = 109 * 105 | | |
| | | Premium 1 | | | |
| 114 | None | Estimated Annual | | | |
| | | Premium 2 | | | |
| 115 | None | Estimated Annual | | | |
| | | Premium 3 | | | |
| 116 | None | Estimated Annual | | | |
| | | Premium 4 | | | |
| 117 | None | Specify Additional | Rapids | Rapids_Comments | |
| | | Coverages/Endorsements | | | |
| 118 | None | Total Factor | | | |
| 119 | None | Total Factored Premium | | | |
| 120 | None | Increased Limits Factor | | | |
| 121 | None | Increased Limits Factored | | | |
| | | Premium | | | |
| 122 | None | Deductible Factor | | | |
| 123 | None | Deductible Factored | | | |
| | | Premium | | | |
| 124 | None | Experience Modification | Rapids | Rapids_XMOD | XMODSEQNO |
| | | Factor | | | |
| 125 | None | Experience Modification | | | |
| | | Factored Premium | | | |
| 126 | None | Loss Constant | | | |
| 127 | None | Loss Constant Factored | | | |
| | | Premium | | | |
| 128 | None | Assigned Risk Surcharge | | | |
| | | Factor | | | |
| 129 | None | Assigned Risk Surcharge | | | |
| | | Factored Premium | | | |
| 130 | None | ARAP Factor | | | |
| 131 | None | ARAP Factored Premium | | | |
| 132 | None | Premium Discount Factor | | | |
| 133 | None | Premium Discount Factored | | | |
| | | Premium | | | |
| 134 | None | Expense Constant | | | |
| 135 | None | Expense Constant Factored | | | |
| | | Premium | | | |
| 137 | None | Total Est Annual Premium | | | |
| 138 | None | Minimum Premium | | | |
| 139 | None | Deposit Premium | | | |
| 140 | None | 1st Column 1 | | | |
| 141 | None | 1st Column 2 | | | |
| 142 | None | 1st Column 3 | | | |
| 143 | None | 1st Column 4 | | | |
| 144 | None | 1st Column 5 | | | |
| 145 | None | Name 1 | Rapids | app_individual | Name |
| 146 | None | Name 2 | Rapids | app_individual | Name |
| 147 | None | Name 3 | Rapids | app_individual | Name |
| 148 | None | Name 4 | Rapids | app_individual | Name |
| 149 | None | Name 5 | Rapids | app_individual | Name |
| 150 | None | Date of Birth 1 | Rapids | app_individual | DOB |
| 150.1 | None | Social Sec No | Rapids | app_individual | SSN |
| 151 | None | Date of Birth 2 | Rapids | app_individual | DOB |
| 152 | None | Date of Birth 3 | Rapids | app_individual | DOB |
| 153 | None | Date of Birth 4 | Rapids | app_individual | DOB |
| 154 | None | Date of Birth 5 | Rapids | app_individual | DOB |
| 155 | None | Title/Relationship 1 | Rapids | Rapids_Individual | Title |
| 156 | None | Title/Relationship 2 | Rapids | Rapids_Individual | Title |
| 157 | None | Title/Relationship 3 | Rapids | Rapids_Individual | Title |
| 158 | None | Title/Relationship 4 | Rapids | Rapids_Individual | Title |
| 159 | None | Title/Relationship 5 | Rapids | Rapids_Individual | Title |
| 160 | None | Ownership Percentage 1 | Rapids | Rapids_Individual | Ownership |
| 161 | None | Ownership Percentage 2 | Rapids | Rapids_Individual | Ownership |
| 162 | None | Ownership Percentage 3 | Rapids | Rapids_Individual | Ownership |
| 163 | None | Ownership Percentage 4 | Rapids | Rapids_Individual | Ownership |
| 164 | None | Ownership Percentage 5 | Rapids | Rapids_Individual | Ownership |
| 165 | None | Duties 1 | Rapids | Rapids_Individual | Duties |
| 166 | None | Duties 2 | Rapids | Rapids_Individual | Duties |
| 167 | None | Duties 3 | Rapids | Rapids_Individual | Duties |
| 168 | None | Duties 4 | Rapids | Rapids_Individual | Duties |
| 169 | None | Duties 5 | Rapids | Rapids_Individual | Duties |
| 170 | None | Inc/Exc 1 | Rapids | Rapids_Individual | IncExc |
| 171 | None | Inc/Exc 2 | Rapids | Rapids_Individual | IncExc |
| 172 | None | Inc/Exc 3 | Rapids | Rapids_Individual | IncExc |
| 173 | None | Inc/Exc 4 | Rapids | Rapids_Individual | IncExc |
| 174 | None | Inc/Exc 5 | Rapids | Rapids_Individual | IncExc |
| 175 | None | Class Code 1 | Rapids | Rapids_Individual | ClassCD |
| 176 | None | Class Code 2 | Rapids | Rapids_Individual | ClassCD |
| 177 | None | Class Code 3 | Rapids | Rapids_Individual | ClassCD |
| 178 | None | Class Code 4 | Rapids | Rapids_Individual | ClassCD |
| 179 | None | Class Code 5 | Rapids | Rapids_Individual | ClassCD |
| 180 | None | Renumeration 1 | Rapids | Rapids_Individual | Renumeration |
| 181 | None | Renumeration 2 | Rapids | Rapids_Individual | Renumeration |
| 182 | None | Renumeration 3 | Rapids | Rapids_Individual | Renumeration |
| 183 | None | Renumeration 4 | Rapids | Rapids_Individual | Renumeration |
| 184 | None | Renumeration 5 | Rapids | Rapids_Individual | Renumeration |
| 185 | None | Loss Run Attached | | | |
| 186 | None | Year 1 | Rapids | APP_Policy_History | CoverageStartDate |
| 187 | None | Year 2 | Rapids | APP_Policy_History | CoverageStartDate |
| 188 | None | Year 3 | Rapids | APP_Policy_History | CoverageStartDate |
| 189 | None | Year 4 | Rapids | APP_Policy_History | CoverageStartDate |
| 190 | None | Year 5 | Rapids | APP_Policy_History | CoverageStartDate |
| 191 | None | Carrier & Policy Number- | Rapids | APP_Policy_History | CarrierId |
| | | Co: 1 | | | |
| 192 | None | Carrier & Policy Number- | Rapids | Rapids | PrevPolGroup, PrevPolNo, |
| | | Pol #: 1 | | | PrevPolYear, PrevPolSuffix |
| 193 | None | Carrier & Policy Number- | | | |
| | | Co: 2 | | | |
| 194 | None | Carrier & Policy Number- | | | |
| | | Pol #: 2 | | | |
| 195 | None | Carrier & Policy Number- | | | |
| | | Co: 3 | | | |
| 196 | None | Carrier & Policy Number- | | | |
| | | Pol #: 3 | | | |
| 197 | None | Carrier & Policy Number- | | | |
| | | Co: 4 | | | |
| 198 | None | Carrier & Policy Number- | | | |
| | | Pol #: 4 | | | |
| 199 | None | Carrier & Policy Number- | | | |
| | | Co: 5 | | | |
| 200 | None | Carrier & Policy Number- | | | |
| | | Pol #: 5 | | | |
| 201 | None | Annual Premium 1 | Rapids | APP_Policy_History | Premium |
| 202 | None | Annual Premium 2 | | | |
| 203 | None | Annual Premium 3 | | | |
| 204 | None | Annual Premium 4 | | | |
| 205 | None | Annual Premium 5 | | | |
| 206 | None | Mod 1 | Rapids | APP_Policy_History | XMOD |
| 207 | None | Mod 2 | | | |
| 208 | None | Mod 3 | | | |
| 209 | None | Mod 4 | | | |
| 210 | None | Mod 5 | | | |
| 211 | None | # Claims 1 | Rapids | APP_Policy_History | NoDisClaims |
| 212 | None | # Claims 2 | | | |
| 213 | None | # Claims 3 | | | |
| 214 | None | # Claims 4 | | | |
| 215 | None | # Claims 5 | | | |
| 216 | None | Amount Paid 1 | Rapids | APP_Policy_History | Amount Paid + Reserve = |
| | | | | | APH.IncurredLosses |
| 217 | None | Amount Paid 2 | | | |
| 218 | None | Amount Paid 3 | | | |
| 219 | None | Amount Paid 4 | | | |
| 220 | None | Amount Paid 5 | | | |
| 221 | None | Reserve 1 | | | Amount Paid + Reserve = |
| | | | | | APH.IncurredLosses |
| 222 | None | Reserve 2 | | | |
| 223 | None | Reserve 3 | | | |
| 224 | None | Reserve 4 | | | |
| 225 | None | Reserve 5 | | | |
| 226 | None | Comments and | ? | ? | ? |
| | | Descriptions | | | |
| 227 | None | Question 1 | Rapids | Rapids_Question | Question; Answer |
| 228 | None | Question 2 | Rapids | Rapids_Question | Question; Answer |
| 229 | None | Question 3 | Rapids | Rapids_Question | Question; Answer |
| 230 | None | Question 4 | Rapids | Rapids_Question | Question; Answer |
| 231 | None | Question 5 | Rapids | Rapids_Question | Question; Answer |
| 232 | None | Question 6 | Rapids | Rapids_Question | Question; Answer |
| 233 | None | Question 7 | Rapids | Rapids_Question | Question; Answer |
| 234 | None | Question 8 | Rapids | Rapids_Question | Question; Answer |
| 235 | None | Question 9 | Rapids | Rapids_Question | Question; Answer |
| 236 | None | Question 10 | Rapids | Rapids_Question | Question; Answer |
| 237 | None | Question 11 | Rapids | Rapids_Question | Question; Answer |
| 238 | None | Question 12 | Rapids | Rapids_Question | Question; Answer |
| 239 | None | Question 13 | Rapids | Rapids_Question | Question; Answer |
| 240 | None | Question 14 | Rapids | Rapids_Question | Question; Answer |
| 241 | None | Question 15 | Rapids | Rapids_Question | Question; Answer |
| 242 | None | Question 16 | Rapids | Rapids_Question | Question; Answer |
| 243 | None | Question 17 | Rapids | Rapids_Question | Question; Answer |
| 244 | None | Question 18 | Rapids | Rapids_Question | Question; Answer |
| 245 | None | Question 19 | Rapids | Rapids_Question | Question; Answer |
| 246 | None | Question 20 | Rapids | Rapids_Question | Question; Answer |
| 247 | None | Question 21 | Rapids | Rapids_Question | Question; Answer |
| 248 | None | Question 22 | Rapids | Rapids_Question | Question; Answer |
| 248.1 | None | Supplemental Questions | Rapids | Rapids_Question | Question; Answer |
| 249 | Contact Information- | Phone | Rapids | App_Phone? | |
| | Inspection | | | | |
| 250 | Contact Information- | Name | Rapids | App_Address | |
| | Inspection | | | | |
| 251 | Contact Information- | Phone | Rapids | App_Address | |
| | Acctng Record | | | | |
| 252 | Contact Information- | Name | Rapids | App_Address | |
| | Acctng Record | | | | |
| 253 | Contact Information- | Phone | Rapids | App_Address | |
| | Claims Info | | | | |
| 254 | Contact Information- | Name | | | |
| | Claims Info | | | | |
| 255 | None | Remarks | | | |

### APPENDIX B

E-mail exemplars used in communication by the application processing system 102.

### 1. Application Submitted to Carriers

After the Producer completes the eApp form and hits the “Submit” button, the eApp is sent to the Carrier(s) selected by the Producer. When the Carrier(s) receives the eApp an email is generated and sent to the Producer. The e-mail will contain the following:

### To: Producer's E-mail

From: “eApp—Broker Application Entry”
Subj: Your Application has been submitted

### Dear Producer Name:

Thank you for using “eApp”. Your Application for Applicant Name has been sent to Carrier Name. Please use the following information to reference this submission:

### Reference Number: Application Number

### Applicant: Applicant Name

### Address: Applicant Address

### Phone: Applicant Phone #

### Carrier: Carrier Name

### Address: Carrier Office Address

### Phone: Carrier Office #

### 2. Application Assigned

After the District Monitor reviews and assigns the eApp to a District User (Underwriter), an email is generated and sent to the Producer. The e-mail will contain the following:

### To: Producer's E-mail

### From: “Carrier Name—Broker Application Entry”

Subj: Your Application has been received

### Dear Producer Name:

Thank you for using “eApp” to submit your application. Your Application for Applicant Name has been received by Carrier Name. The Underwriter assigned to your application is Assigned To Name.
Please use the following information to reference this submission:
eApplication Id: Application Number

### Applicant: Applicant Name

### Address: Applicant Address

### Phone: Applicant Phone #

### Carrier: Carrier Name

### Address: Carrier Office Address

### Phone: Carrier Office #

### 3. Application Blocked

After the District Monitor reviews the eApp and confirms via TopCat that a previous application existed, an email is generated and sent to the Producer. The e-mail will contain the following:

### To: Producer's E-mail

### From: “Carrier Name—Broker Application Entry”

Subj: Your Application is blocked by another Broker

### Dear Producer Name:

Thank you for using “eApp” to submit your application. Your Application for Applicant Name has been received by Carrier Name. Unfortunately, this applicant has previously submitted an application with another Broker.
Please use the following information to reference this submission if you wish to pursue the matter:
eApplication Id: Application Number

### Applicant: Applicant Name

### Address: Applicant Address

### Phone: Applicant Phone #

### Carrier: Carrier Name

### Address: Carrier Office Address

### Phone: Carrier Office #

### 4. Application Cancelled

If the District Monitor cancels the eApp via the “bomb” icon on the eApplications Received page, an email is generated and sent to the Producer. The e-mail will contain the following:

### To: Producer's E-mail

### From: “Carrier Name—Broker Application Entry”

Subj: Your Application has been cancelled

### Dear Producer Name:

Thank you for using “eApp” to submit your application. Your Application for Applicant Name has been received and cancelled by Carrier Name.
Please use the following information to reference this submission if you wish to pursue the matter:
eApplication Id: Application Number

### Applicant: Applicant Name

### Address: Applicant Address

### Phone: Applicant Phone #

### Carrier: Carrier Name

### Address: Carrier Office Address

### Phone: Carrier Office #

E-mail Message to eApp Monitor

### 5. Application Received

After the Producer creates and submits an eApp, an email is generated and sent to the eApp Monitor in the appropriate district. The district is selected based upon the zip code of the Producer. The e-mail will contain the following:
   To: eApp Monitor's E-mail
   From: trigger@rapidscontrol.com
   Subj: eApplication Received
   The following eApplication has been received and assigned to your office:
   eApplication Id: Application Number

### Applicant: Applicant Name

### Address: Applicant Address

### Phone: Applicant Phone #

### Producer: Producer Name

### Address: Producer Office Address

### Phone: Producer Office #

Email: Producer email
Link to eApplication Received:
hyperlink to eApplication Received page with identified eApp
E-mail Message to eApp User

### 6. Application Assigned

After the eApp Monitor reviews and assigns the eApp to a eApp User, an email is generated and sent to the eApp User in the district. The e-mail will contain the following:
   To: eApp User's E-mail
   From: trigger@rapidscontrol.com
   Subj: eApplication Assigned
   The following eApplication has been received and assigned to you:
   eApplication Id: Application Number

### Applicant: Applicant Name

### Address: Applicant Address

### Phone: Applicant Phone #

### Producer: Producer Name

### Address: Producer Office Address

### Phone: Producer Office #

Email: Producer email
Link to ACORD form:
hyperlink to eApplication ACORD form
E-mail Message to District User with Clearance Rights

### 7. Clearance Request

If the eApp Monitor who does not have TopCat clearance rights selects a user from the drop down list in the Status column and clicks the Stop Sign, an email is generated and sent to that User. The e-mail will contain the following:

### To: User's E-mail

From: trigger@rapidscontrol.com
Subj: eApplication TopCat Hit
The eApplication with an Id number of Application Number has encountered a hit in TopCat.
Please review and take appropriate action.

### Thanks

### Link to TopCat:

Hyperlink to TopCat with ID Number
Link to ACORD form:
Hyperlink to eApplication ACORD form

What is claimed is:

1. A method for electronically processing an insurance application, the method comprising the steps of:
receiving user input;
receiving risk data;
selecting a plurality of insurers;
generating an application for each selected insurer from the received risk data and the receive user input; and
sending the application to each selected insurer in digital form.
